(19) United States
(12) Patent Application Publication
(10) Pub. No.: US 2018/0116903 A1
(43) Pub. Date: May 3, 2018

(54) BEAUTY DEVICE

(71) Applicant: MTG Co., Ltd., Nagoya-shi (JP)

(72) Inventor: Tsuyoshi Matsushita, Nagoya-shi (JP)

(21) Appl. No.: 15/562,493

(22) PCT Filed: Dec. 23, 2016
(86) PCT No.: PCT/JP2016/088594

§ 371 Date: Sep. 28, 2017

(30) Foreign Application Priority Data
Dec. 28, 2015 (JP) 2015-255787
Jul. 27, 2016 (JP) 2016-147885
Jul. 27, 2016 (JP) 2016-147886

(51) Int. Cl. A61H 15/00; A61H 7/00

(52) U.S. Cl. CPC A61H 15/0085; A61H 15/0092; A61H 2007/009; A61H 2015/005; A61H 2201/10; A61H 7/007

(57) ABSTRACT

A beauty device includes a handle; a roller unit having two rotatable rollers; and a roller unit shaft interposed between the roller unit and the handle and configured to rotatably support the roller unit with respect to the handle, wherein, when viewed in a direction of an axis of the roller unit shaft, the axis of the roller unit shaft is located at a position separated from a virtual straight line passing through centers of gravity of the two rollers.

### TECHNICAL FIELD

This disclosure relates to a beauty device.

### BACKGROUND

Conventionally, a variety of beauty devices that press skin with rollers and exerts a massage effect have been proposed. As an example of this beauty device, a beauty device equipped with a roller unit having two rollers is disclosed in Japanese Unexamined Patent Application Publication No. 2000-175984. In the roller unit, the rollers are rotatably supported at opposite ends of the roller shaft, and the roller unit is rotatably mounted on a handle via a roller unit shaft. The roller shaft is located on an extension line of the roller unit shaft, and the roller shaft is perpendicular to the roller unit shaft. With such a configuration, when the two rollers are brought into contact with outer skin, the roller unit is rotated via the roller unit shaft according to a direction in which the outer skin is directed. Thereby, without greatly twisting a wrist with the handle grasped, both of the rollers can be rolled along the outer skin.

However, in the configuration disclosed in JP '984, as described above, the roller shaft having the rollers at the opposite ends thereof is located on the extension line of the roller unit shaft. For this reason, it is difficult to secure a trail length that is a distance between a center position of a contact region with the roller on the outer skin and an intersection position between the extension line of the roller unit shaft and the outer skin in a traveling direction. As a result, rectilinear stability of the rollers is low, and it is difficult to smoothly roll the rollers in a state in which the rollers are in contact with the outer skin directed in various directions. For this reason, use becomes difficult, and a feeling of use is also easily deteriorated. Meanwhile, the handle is sufficiently laid down with respect to the outer skin, and thereby a caster angle that is an angle formed by the roller unit shaft and a normal of the outer skin is increased to secure the trail length, and the rectilinear stability can be enhanced. In this case, since a pressing force against the outer skin from the rollers is easily reduced, it is difficult to obtain a sufficient massage effect.

It could therefore be helpful to provide a beauty device that is easy to use, has a good feeling of use, and has an excellent massage effect.

### SUMMARY

We thus provide:

A beauty device that includes:

a handle;

a roller unit having two rollers provided rotatably; and a roller unit shaft interposed between the roller unit and the handle and configured to rotatably support the roller unit with respect to the handle,

wherein, when viewed in a direction of an axis of the roller unit shaft, the axis of the roller unit shaft is located at a position separated from a virtual straight line passing through the centers of gravity of the two rollers.

According to the beauty device, when viewed in the direction of the axis of the roller unit shaft, the centers of gravity of the rollers are located at positions shifted from the axis of the roller unit shaft. For this reason, when the rollers are brought into contact with outer skin, a trail length can be increased without excessively laying down the handle, and the caster angle is increased. For this reason, rectilinear stability of the rollers is improved, and thus the rollers are easily made to go straight along the outer skin directed in various directions without greatly twisting a wrist. Thereby, the beauty device is easily used, and has a good feeling of use. Since the handle does not need to be excessively laid down with respect to the outer skin, a pressing force against the outer skin from the rollers can be maintained. As a result, an excellent massage effect is exerted.

As described above, the beauty device that is easy to use, has a good feeling of use, and has an excellent massage effect can be provided.

### BRIEF DESCRIPTION OF THE DRAWINGS

FIG. 1 is a top view of a beauty device in Example 1.

FIG. 2 is a cutaway side view taken along position II-II in FIG. 1.

FIG. 3 is a front view of the beauty device in Example 1.

FIG. 4 is an exploded perspective view of a roller unit in Example 1.

FIG. 5 is a sectional view taken along line V-V in FIG. 2.

FIG. 6 is a front perspective view of the roller unit from which rollers and an upper cover are removed in Example 1.

FIG. 7 is a perspective view of a roller unit shaft and a washer in Example 1.

FIG. 8 is a top view of a beauty device in Modification 1.

FIG. 9 is a front view of the beauty device in Modification 1.

FIG. 10 is a cutaway side view in Modification 1.

FIG. 11 is a top view of a beauty device in Example 2.

FIG. 12 is a cutaway side view taken along position XII-XII in FIG. 11.

FIG. 13 is a top view of a beauty device in Example 3.

FIG. 14 is a sectional view taken along position XIV-XIV in FIG. 13.

FIG. 15 is a top view of a beauty device in Example 4.

FIG. 16 is a side view of the beauty device in Example 4.

FIG. 17 is a cutaway side view taken along position XVII-XVII in FIG. 15.

FIG. 18 is a front view of a roller unit in Example 4.

FIG. 19 is an exploded perspective view of the roller unit in Example 4.

FIG. 20 is a sectional view taken along position XX-XX in FIG. 16.

FIG. 21 is a top view of a beauty device in Example 5.

FIG. 22 is a side view of the beauty device in Example 5.

FIG. 23 is a front view of the beauty device in Example 5.

FIG. 24 is a top view of a beauty device in Modification 2.

FIG. 25 is a top view of a beauty device in Modification 3.

FIG. 26 is a top view of a beauty device in Example 6.

FIG. 27A is a side view illustrating a first use mode of the beauty device in Example 6, and FIG. 27B is a side view illustrating a second use mode of the beauty device in Example 6.

FIG. 28 is a bottom view illustrating a third use mode of the beauty device in Example 6.

FIG. 29 is a bottom view illustrating a use state of a beauty device in Modification 4.

FIG. 30 is a top view of a beauty device in Example 7.

FIG. 31 is a front view of the beauty device in Example 7.

FIG. 32 is a top view of a beauty device in Example 8.

FIG. 33 is a top view of a beauty device in Modification 5.

FIG. 34 is a perspective view of a beauty device in Example 9.

FIG. 35 is a top view of the beauty device in Example 9.

FIG. 36 is a front view of the beauty device in Example 9.

FIG. 37 is a side view of the beauty device in Example 9.

FIG. 38 is a sectional view taken along a position of line XXXVIII-XXXVIII in FIG. 35.

FIG. 39 is a sectional view taken along a position of line XXXIX-XXXIX in FIG. 35.

FIG. 40 is an exploded perspective view of the beauty device in Example 9.

FIG. 41 is a front view of a roller unit in Example 9.

FIG. 42 is a schematic view illustrating a use state of the beauty device in Example 9.

FIG. 43 is a schematic view illustrating the use state of the beauty device in Example 9.

FIG. 44 is a schematic view illustrating the use state of the beauty device in Example 9.

FIG. 45 is a schematic view illustrating the use state of the beauty device in Example 9.

FIG. 46 is a schematic view illustrating the use state of the beauty device in Example 9.

FIG. 47 is a schematic view illustrating the use state of the beauty device in Example 9.

FIG. 48 is a schematic view illustrating the use state of the beauty device in Example 9.

FIG. 49 is a schematic view illustrating the use state of the beauty device in Example 9.

FIG. 50 is a schematic view illustrating the use state of the beauty device in Example 9.

FIG. 51 is a schematic view illustrating the use state of the beauty device in Example 9.

FIG. 52 is a schematic view illustrating the use state of the beauty device in Example 9.

FIGS. 53A to 53D are perspective views of a roller in a modification.

FIG. 54 is a top view of a beauty device in Example 10.

FIG. 55 is a side view of a beauty device in Example 10.

### DETAILED DESCRIPTION

The center of gravity of a roller referred to herein is a geometric center of gravity of the roller.

The roller unit preferably includes a pair of roller shafts that rotatably support the rollers at distal ends thereof and are provided such that the distal ends are open. In this case, since the pair of roller shafts serving as rotational shafts of the rollers are disposed in a tapered shape, the outer skin can be picked up by the pair of rollers, and an excellent massage effect is exerted. Further, since a close-contact characteristic between the rollers and the outer skin is further improved, the roller unit is easily rotated via the roller unit shaft such that a state in which the rollers are brought contact with the outer skin is maintained. As a result, when the beauty device is moved along the outer skin, followability of the rollers is improved.

A proximal end side of the roller unit shaft and the handle are preferably connected, and a distal end side of the roller unit shaft and the roller unit are preferably connected.

The pair of roller shafts are preferably located on the same plane, and are preferably inclined with respect to the axis of the roller unit shaft. In this case, as the pair of rollers move to the distal end side of the roller unit shaft in a direction parallel to the outer skin in a state in which the pair of rollers are applied to the outer skin, the outer skin can be pressed by the pair of rollers. As the pair of rollers move to the proximal end side opposite to the distal end side of the roller unit shaft in the direction parallel to the outer skin, the outer skin can be picked up. Thereby, a massaging effect caused by the pressing and the picking up of the outer skin is obtained, and a more excellent massage effect is exerted.

The roller unit is preferably provided in at least one pair. In this case, at least four rollers are provided. Since these rollers can assist to massage the outer skin, a more excellent massage effect is exerted.

The pair of roller units are preferably disposed symmetrically with respect to a central axis of the handle. In this case, since each roller is easily brought into contact with the outer skin in a state in which the handle is grasped, use becomes easier, and a massage effect is improved.

The roller unit is preferably provided in at least two pairs. In this case, since at least eight rollers can assist to massage the outer skin, a more excellent massage effect is exerted.

### EXAMPLES

### Example 1

Examples of a beauty device will be described below.

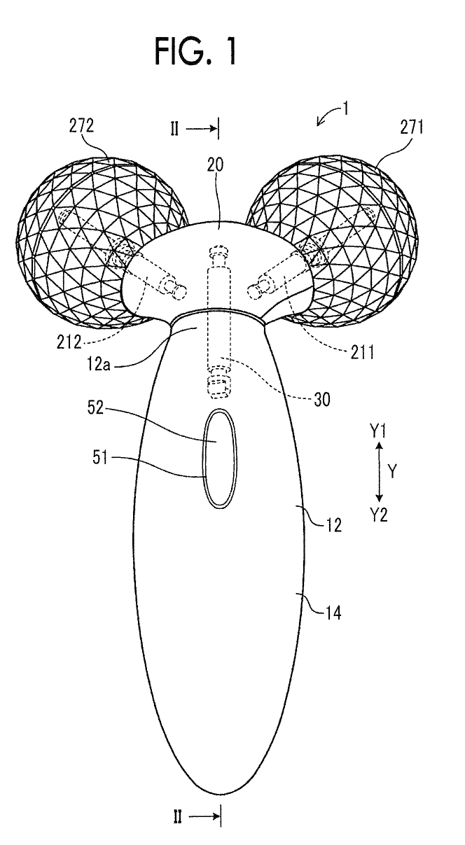

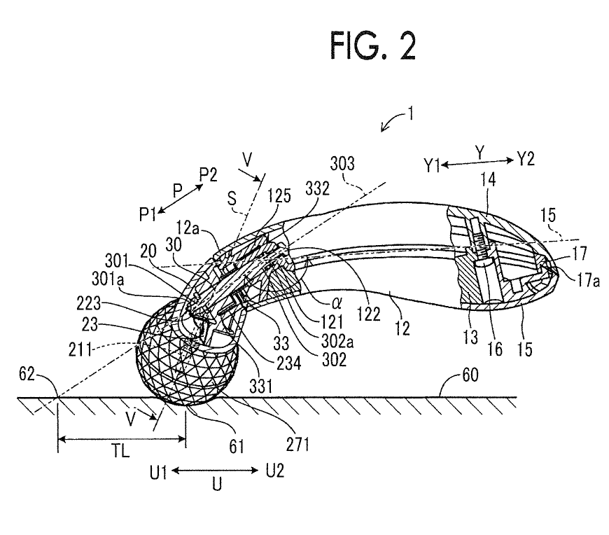

As illustrated in FIGS. 1 and 2, a beauty device 1 in Example 1 includes a handle 12, a roller unit 20, and a roller unit shaft 30.

Two rollers 271 and 272 are rotatably provided for the roller unit 20.

The roller unit shaft 30 is interposed between the roller unit 20 and the handle 12, and rotatably supports the roller unit 20 on the handle 12.

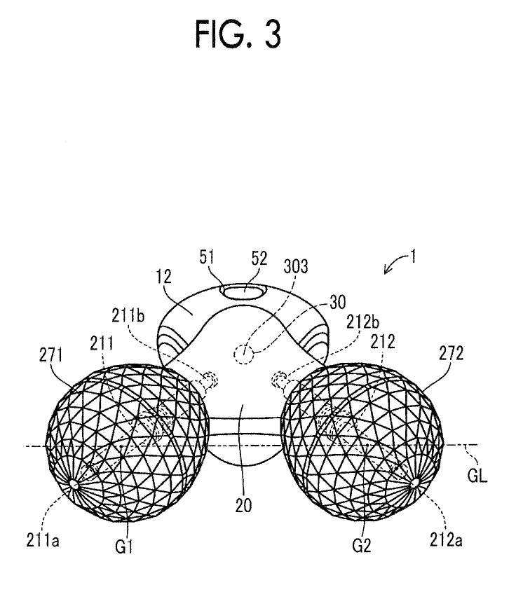

As illustrated in FIG. 3, when viewed from a direction P of the axis of the roller unit shaft 30, an axis 303 of the roller unit shaft 30 is located at a position at which the axis is separated from a virtual straight line GL passing the centers of gravity G1 and G2 of the two rollers 271 and 272.

Hereinafter, the beauty device 1 of this example will be described in detail.

As illustrated in FIG. 1, the beauty device 1 includes the handle 12 having an approximate rod shape, and the roller unit 20 located at a distal end side Y1 of the handle 12 in a longitudinal direction of the handle 12. As illustrated in FIG. 2, the handle 12 includes a base body 13, a first cover body 14, and a second cover body 15. A ring-shaped packing 17 is integrated with and firmly fixed to an entire outer circumferential edge of the base body 13. A lip part 17a, which can be engaged with an inner circumferential edge of an opening of the first cover body 14, is formed on the packing 17. The first cover body 14 and the second cover body 15 are mounted on the base body 13, and the lip part 17a of the packing 17 is brought into contact with the inner circumferential edge of the opening of the first cover body 14 under a pressure. Thereby, water is prevented from forcibly entering the inside of the handle 12 from a gap between the first cover body 14 and the second cover body 15. This inhibits water from reaching electric components provided for the base body 13 inside the handle 12.

As illustrated in FIGS. 1 to 3, the roller unit 20 is provided at the distal end side Y1 of the handle 12 in the longitudinal direction Y of the handle 12. The roller unit 20 includes the two rollers 271 and 272. The rollers 271 and 272 are provided at distal ends 211a and 212a of a pair of roller shafts 211 and 212.

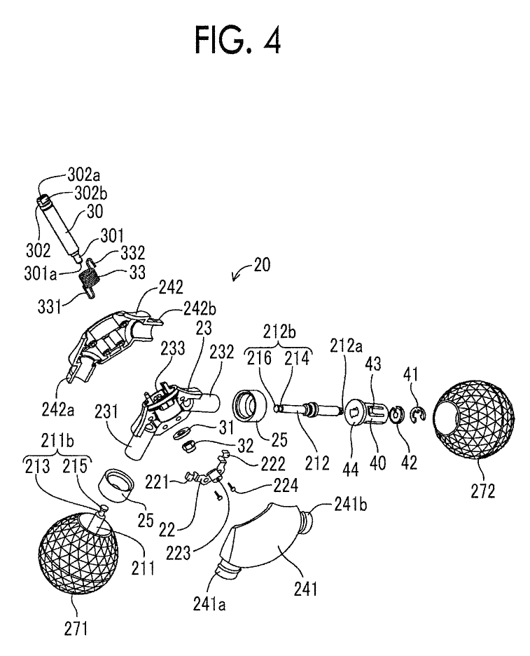

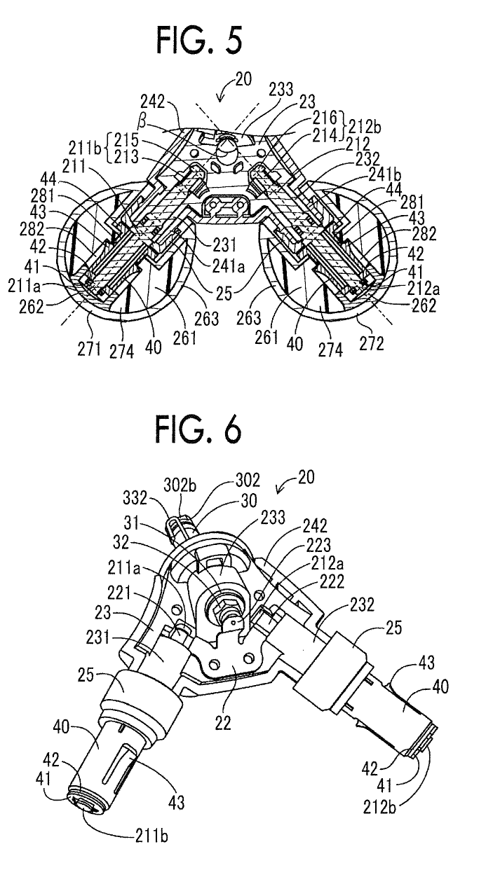

As illustrated in FIGS. 4 and 5, the pair of roller shafts 211 and 212 are inserted into a pair of cylindrical parts 231 and 232 formed at a unit base 23, respectively. Proximal ends 211b and 212b of the pair of roller shafts 211 and 212 are exposed from the cylindrical parts 231 and 232, respectively. Constricted parts 213 and 214 whose diameters are reduced are provided at the proximal ends 211b and 212b of the pair of roller shafts 211 and 212, and retaining head parts 215 and 216 whose diameters are larger than those of the constricted parts 213 and 214 are formed at further proximal end sides of the constricted parts 213 and 214.

As illustrated in FIG. 6, a shaft holder 22 is disposed between the pair of cylindrical parts 231 and 232 in the unit base 23. As illustrated in FIGS. 4 and 6, semi-cylindrical pressing parts 221 and 222 for pressing the constricted parts 213 and 214 of the pair of roller shafts 211 and 212 are formed at opposite ends of the shaft holder 22. As illustrated in FIG. 6, the shaft holder 22 is fixed to the unit base 23 and a rear unit cover 242 (to be described below) by screws 224 (see FIG. 4) in a state in which the constricted parts 213 and 214 of the pair of roller shafts 211 and 212 are pressed by the pressing parts 221 and 222 of the shaft holder 22. Thereby, as illustrated in FIG. 5, the pair of roller shafts 211 and 212 are supported and retained in a state in which they are fitted into the support tubes 231 and 232 of the unit base 23. As illustrated in FIG. 4, the unit base 23 is covered with a front unit cover 241 and a rear unit cover 242. The front unit cover 241 and the rear unit cover 242 are formed with semi-cylindrical support tube cover parts 241a, 241b, 242a, and 242b, and cover the pair of support tubes 231 and 232.

As illustrated in FIGS. 4 and 5, cylindrical caps 25 formed of a synthetic resin are fitted around the support tube cover parts 241a, 241b, 242a, and 242b. The support tube cover parts 241a, 241b, 242a, and 242b and the support tubes 231 and 232 are sealed by the caps 25, and rattling of the roller shafts 211 and 212 is prevented. Electric insulation between the roller unit 20 and outer surfaces of the rollers 271 and 272 (to be described below) is secured by the caps 25.

As illustrated in FIG. 4, a bearing 40 is mounted on each of the roller shafts 211 and 212. Each of the bearings 40 is formed of a synthetic resin, and has a cylindrical shape. As illustrated in FIGS. 4 and 5, the roller shafts 211 and 212 are inserted inside the bearings 40, and the bearings 40 are retained and fixed via bearing spacers 42 by stop rings 41 mounted on the distal ends 211a and 212a of the roller shafts 211 and 212. Metal plating is performed on entire outer surfaces including both front and back surfaces of each of the bearings 40, and electrical conduction between the bearings 40 and the roller shafts 211 and 212 is secured. In place of the metal plating, the bearings 40 may be formed of a conductive resin, and thereby the electrical conduction of both may be secured.

As illustrated in FIGS. 4 and 5, locking claws 43 are formed on an outer circumferential surface of the bearing 40 by protruding outward in a radial direction. As illustrated in FIG. 5, step parts 281 of the rollers 271 and 272 (to be described below) are engaged with the locking claws 43. A diameter enlarged part 44 whose diameter is enlarged in the outer side Y1 in a radial direction is formed at an end of each of the bearings 40. Each of the step parts 281 is located between the locking claws 43 and the diameter enlarged part 44. Each of the step parts 281 comes into contact with the locking claws 43 and the diameter enlarged part 44, and is clipped by both. Thereby, the rollers 271 and 272 are positioned with respect to the roller shafts 211 and 212, and rattling of the rollers 271 and 272 is reduced.

As illustrated in FIGS. 4 and 5, the rollers 271 and 272 are rotatably supported along with the bearings 40 by the roller shafts 211 and 212 via the bearings 40 provided for the roller shafts 211 and 212. As illustrated in FIG. 5, each of the rollers 271 and 272 is made up of a core 261 formed of a synthetic resin, a cap member 262 that is fitted into an inner circumference of a distal end of the core 261 and is formed of a synthetic resin, and a sheath member 263 that is covered on outer circumferences of the core 261 and the cap member 262 and is formed of a synthetic resin. Conductive metal plating acting as a conductive part is performed on an outer surface of the sheath member 263, and electrical conduction between the bearing 40 and the sheath member 263 is secured. A space 282 in which the bearing 40 is inserted and disposed is formed inside the core 261. The step part 281 engageable with the locking claws 43 is formed on an inner wall surface of the space 282. The bearing 40 is inserted and disposed in the space 282, and the locking claws 43 are engaged with the step part 281. Thereby, the rollers 271 and 272 are retained with respect to the bearings 40. As a result, the rollers 271 and 272 are provided to cover the distal ends 211a and 212a of the pair of roller shafts 211 and 212, respectively.

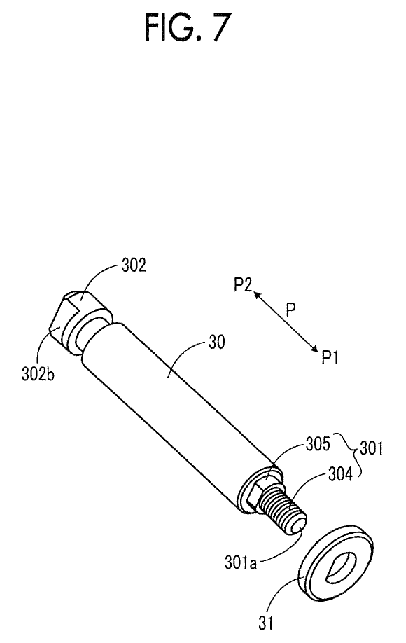

As illustrated in FIG. 6, a shaft mounting part 233 to which the roller unit shaft 30 is connected is formed at the roller unit 20. The roller unit shaft 30 has an approximate rod shape. The shaft mounting part 233 has an approximately cylindrical shape, and a distal end 301 of the roller unit shaft 30 illustrated in FIG. 7 is inserted into the shaft mounting part 233. As illustrated in FIG. 7, a male threaded part 304 on which thread cutting is performed on an outer circumferential surface of the distal end 301 of the roller unit shaft 30 is formed at the distal end 301 of the roller unit shaft 30. A D-shaped portion 305 is formed at a proximal end side P2 of the male threaded part 304 by reducing a diameter of the outer circumferential surface of the roller unit shaft 30 and cutting out a part of the outer circumferential surface of the roller unit shaft 30.

As illustrated in FIGS. 4 and 6, the roller unit shaft 30 is inserted into the shaft mounting part 233, and the male threaded part 304 and the D-shaped portion 305 protrude from the shaft mounting part 233. A washer 31 and a nut 32 are mounted on the D-shaped portion 305 and the male threaded part 304. As illustrated in FIG. 7, an inside shape of the washer 31 is formed in a D shape along the D-shaped portion 305, and a thickness of the washer 31 and a height of the D-shaped portion 305 are approximately identical to each other. Thereby, the roller unit shaft 30 is rotatably retained in and fixed to the shaft mounting part 233. The inside shape of the washer 31 is formed in a D shape along the D-shaped portion 305, and even when the rollers 271 and 272 are rotated, the washer 31 does not rotate in association with the rotation. For this reason, since rotating forces of the rollers 271 and 272 are not transferred to the nuts 32, looseness of the nuts 32 caused by the rotation of the rollers 271 and 272 is prevented. Further, as illustrated in FIG. 2, a convex piece 223 formed at the shaft holder 22 is in contact with a distal end face 301a of the roller unit shaft 30. Thereby, electrical conduction between the roller unit shaft 30 and the shaft holder 22 is secured.

As illustrated in FIG. 2, a threaded hole 302a is formed in a proximal end 302 of the roller unit shaft 30. A tubular roller unit shaft mounting part 121, an inner surface of which has a shape that follows a lateral surface of the proximal end 302 of the roller unit shaft 30, is formed inside a distal end of the handle 12. In a state in which the proximal end 302 of the roller unit shaft 30 is located inside the roller unit shaft mounting part 121, a screw 122 is screwed into the threaded hole 302a, and thereby the roller unit shaft 30 is threadedly fixed to the roller unit shaft mounting part 121. That is, the distal end 301 side of the roller unit shaft 30 is connected to the roller unit 20, and the proximal end 302 side of the roller unit shaft 30 is connected to the distal end 12a of the handle 12. In this way, the roller unit 20 is rotatably mounted on the distal end 12a of the handle 12. As illustrated in FIG. 7, a cutout surface 302b obtained by cutting out a part of the proximal end 302 of the roller unit shaft 30 is formed at the proximal end 302 of the roller unit shaft 30. Thereby, the proximal end 302 of the roller unit shaft 30 is prevented from rotating in the roller unit shaft mounting part 121, and looseness of the screw 122 is prevented.

As illustrated in FIGS. 2 and 4, a spring 33 that is a torsion spring is inserted into the roller unit shaft 30. As illustrated in FIG. 2, a first end 331 that is one end of the spring 33 is engaged with a first spring engaging part 234 formed at the unit base 23. On the other hand, a second end 332 that is the other end of the spring 33 is engaged with a second spring engaging part 125 formed inside the distal end 12a of the handle 12. Thereby, the roller unit 20 is biased to return to a predetermined initial position. In this example, the roller unit 20 can be rotated within a range of −90° to 90° from the predetermined initial position.

As illustrated in FIG. 2, the roller unit shaft 30 is inclined with respect to the longitudinal direction Y of the handle 12 to be directed to the distal end side Y1 of the handle 12 in the longitudinal direction Y from the proximal end 302 toward the distal end 301 of the roller unit shaft 30. In this example, an angle α formed between the roller unit shaft 30 and the axis 15 in the longitudinal direction Y of the handle 12 is 125°.

As illustrated in FIG. 5, the pair of roller shafts 211 and 212 are located on the same plane S (see FIG. 2). As illustrated in FIG. 2, the roller shafts 211 and 212 are inclined with respect to the axis 303 of the roller unit shaft 30. As illustrated in FIG. 5, the pair of roller shafts 211 and 212 are held by the shaft holder 22 such that the distal ends 211a and 212a thereof are open. In this example, an angle β formed by the pair of roller shafts 211 and 212 on the same plane is 80°.

As illustrated in FIG. 3, when viewed in the direction P of the axis 303 of the roller unit shaft 30 (see FIG. 2), the axis 303 of the roller unit shaft 30 is located at a position at which it is separated from the virtual straight line GL passing through the centers of gravity G1 and G2 of the pair of rollers 271 and 272. That is, the axis 303 and the virtual straight line GL do not intersect.

As illustrated in FIGS. 1 and 3, a through-hole 51 is formed in the first cover body 14 on an upper surface of the handle 12. A light-receiving lens 52 formed of a transparent synthetic resin is fitted into the through-hole 51 via a seal material (not shown). A solar cell panel (not shown) is disposed at the base body 13 on an inner side of the light-receiving lens 52 (at an interior of the handle 12). Positive and negative output terminals of the solar cell panel are connected to a conductive part of an outer surface of the handle 12 and the roller unit shaft 30. The seal material prevents intrusion of water into the handle 12.

As illustrated in FIG. 2, the beauty device 1 of this example is used by moving the roller 271 (272) in the longitudinal direction Y of the handle 12 in a state in which the handle 12 is grasped to bring the roller 271 (272) into contact with outer skin 60. In the outer skin 60, a distance between a center position 61 of a contact region with respect to the roller 271 and an intersection position 62 between the axis 303 of the roller unit shaft 30 and the outer skin 60 becomes a trail length TL.

Next, an operation and effects in the beauty device 1 of this example will be described in detail.

According to the beauty device 1 of this example, when viewed in the direction P of the axis of the roller unit shaft 30, the centers of gravity G1 and G2 of the rollers 271 and 272 are located at positions shifted from the axis 303 of the roller unit shaft 30. For this reason, when the rollers 271 and 272 are brought into contact with the outer skin 60, the trail length TL can be increased without excessively laying down the handle 12. For this reason, rectilinear stability of the rollers 271 and 272 is improved, and thus the rollers 271 and 272 are easily made to go straight along the outer skin 60 directed in various directions without greatly twisting a wrist. Thereby, the beauty device 1 is easily used, and has a good feeling of use. Since the handle 12 does not need to be excessively laid down with respect to the outer skin 60, a pressing force against the outer skin 60 from the rollers 271 and 272 can be maintained. As a result, an excellent massage effect is exerted.

In this example, the roller unit 20 includes the pair of roller shafts 211 and 212 that rotatably support the rollers 271 and 272 at the distal ends 211a and 212a thereof and are provided such that the distal ends 211a and 212a thereof are open. Thereby, the pair of roller shafts 211 and 212 serving as rotational shafts of the rollers 271 and 272 are disposed in a tapered shape. Thus, the outer skin 60 can be picked up by the pair of rollers 271 and 272, and the excellent massage effect is exerted. Further, since a close-contact characteristic between the rollers 271 and 272 and the outer skin 60 is further improved, the roller unit 20 is easily rotated via the roller unit shaft 30 such that a state in which the rollers 271 and 272 are brought contact with the outer skin 60 is maintained. As a result, when the beauty device 1 is moved along the outer skin 60, followability of the rollers 271 and 272 is improved.

In this example, the proximal end 302 side of the roller unit shaft 30 and the handle 12 are connected, and the distal end 301 side of the roller unit shaft 30 and the roller unit 20 are connected. The pair of roller shafts 211 and 212 are located on the same plane, and are inclined with respect to the axis 303 of the roller unit shaft 30. Thereby, as illustrated in FIG. 2, in a state in which the pair of rollers 271 and 272 are applied to the outer skin 60, they move to a distal end side U1 of the roller unit shaft 30 in a direction U parallel to the outer skin 60, and thereby the outer skin 60 can be pressed by the pair of rollers 271 and 272. In the state in which the pair of rollers 271 and 272 are applied to the outer skin 60, they move to a proximal end side U2 opposite to the distal end side U1 of the roller unit shaft 30 in the direction U parallel to the outer skin 60, and thereby the outer skin 60 can be picked up. Thereby, a massaging effect caused by pressing and picking up of the outer skin 60 is obtained, and a more excellent massage effect is exerted.

In this example, the handle 12 has a rod shape. With the approach from the proximal end 302 to the distal end 301 of the roller unit shaft 30, the roller unit shaft 30 is inclined with respect to the longitudinal direction Y of the handle 12 to face the distal end side Y1 of the handle 12 in the longitudinal direction of the handle 12. Thereby, in the state in which the handle 12 is grasped, the rollers 271 and 272 are easily pressed against the outer skin 60, and are easily used.

As described above, according to this example, the beauty device 1 that is easily used, has a good feeling of use, and has an excellent massage effect can be provided.

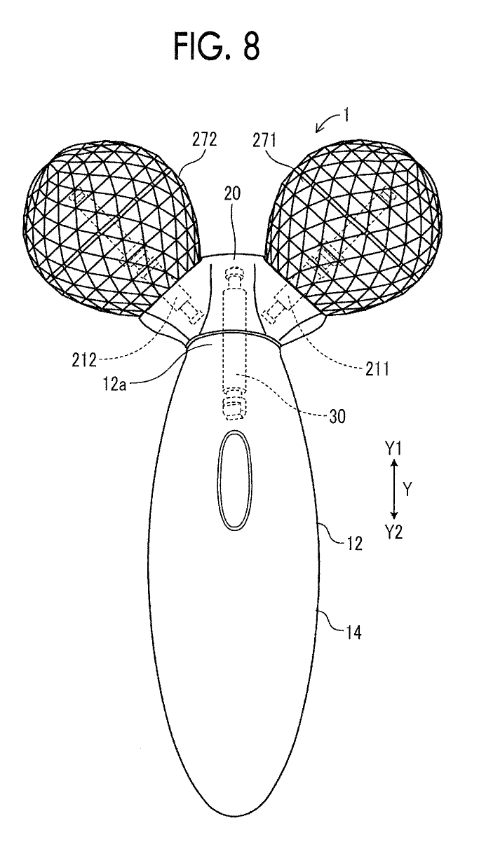

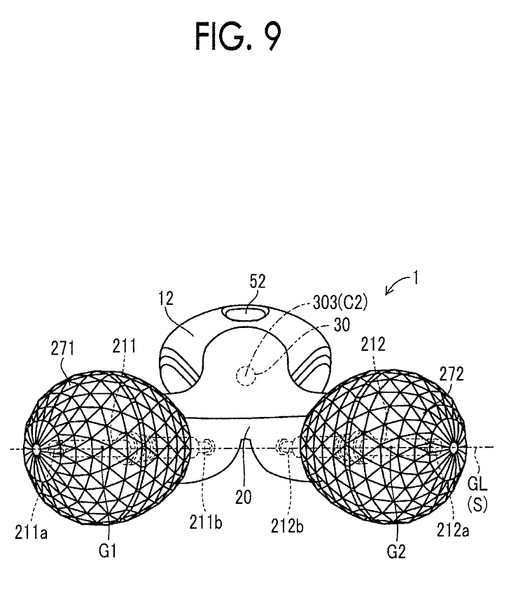

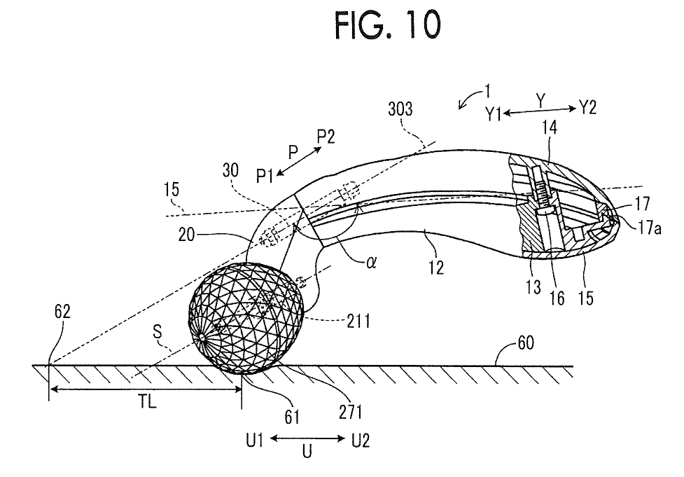

The beauty device 1 illustrated in FIGS. 8 to 10 may be used as Modification 1. In the beauty device 1 of Modification 1, the pair of roller shafts 211 and 212 are located on the same plane S as illustrated in FIG. 9, and the plane S is parallel to the roller unit shaft 30 as illustrated in FIG. 10. In this example, since the trail length TL can be sufficiently lengthened, the rectilinear stability is improved, and the same operation and effects as in the case of Example 1 are obtained.

### Example 2

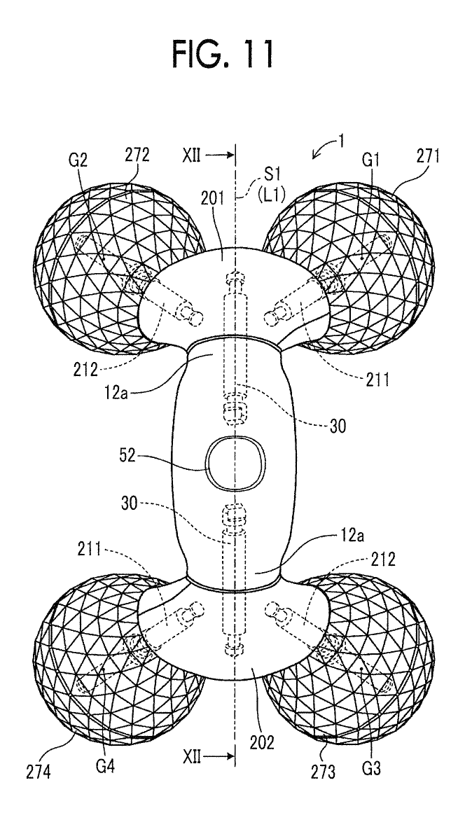

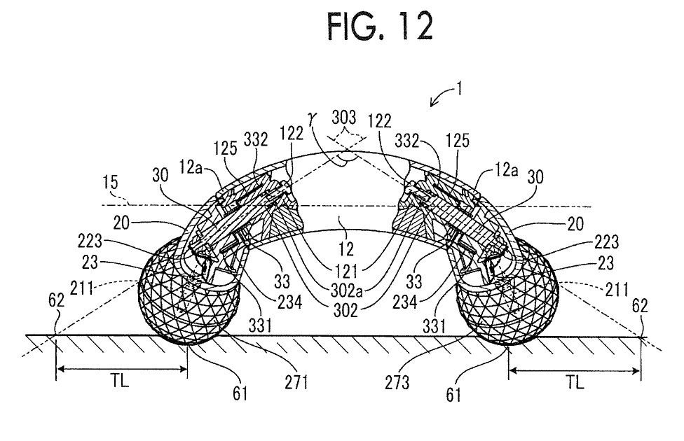

The beauty device 1 of Example 1 includes one roller unit 20, but the beauty device 1 of Example 2 includes a pair of roller units 201 and 202 as illustrated in FIG. 11. The pair of roller units 201 and 202 have the same configuration as the roller unit 20 of Example 1. Centers of gravity G1, G2, G3, and G4 of four rollers 271, 272, 273, and 274 provided for the pair of roller units 201 and 202 are configured to be able to be located on the same plane. Further, as illustrated in FIG. 11, the pair of roller units 201 and 202 are arranged symmetrically with respect to a virtual straight line L1 passing through the center of a handle 12 such that axes of roller unit shafts 30 thereof are located on the same plane S1. As illustrated in FIG. 12, an angle γ formed by the axes 303 of roller unit shafts 30 in this example on the same plane is 120°.

According to the beauty device 1 of this example, the centers of gravity G1 to G4 of the four rollers 271 to 274 are configured to be able to be located on the same plane, and thereby the four rollers 271 to 274 can be simultaneously brought into contact with outer skin 60. Since a massaging effect of the outer skin 60 is exerted by the four rollers 271 to 274, an excellent massage effect is obtained. Further, a massaging effect of skin is also exerted between the roller 271 provided for one roller unit 201 and the roller 273 provided for the other roller unit 202, and the massaging effect of the skin is also exerted between the roller 272 provided for one roller unit 201 and the roller 274 provided for the other roller unit 202. Thus, a more excellent massage effect is obtained. In this example, the same operation and effects as in the case of Example 1 are exerted.

### Example 3

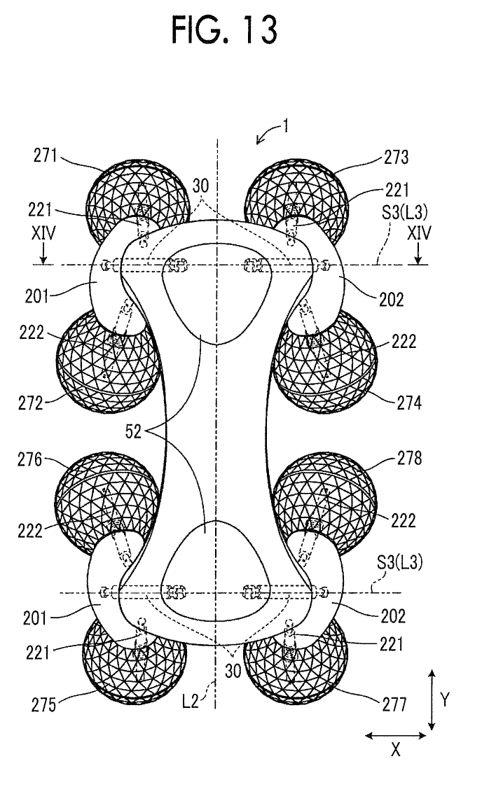

The beauty device 1 of Example 2 includes a pair of roller units 20, but the beauty device 1 of Example 3 includes two pairs of roller units 201, 202, 203, and 204 as illustrated in FIG. 13. The two pairs of roller units 201, 202, 203, and 204 have the same configuration as the roller unit 20 of Example 1.

As illustrated in FIG. 13, in the pair of roller units 201 and 202 among the two pairs of roller units 201, 202, 203, and 204, axes 303 of the roller unit shafts 30 are located on a virtual straight line L3 that is orthogonal to a longitudinal direction Y of a handle 12 at one end side of the handle 12, and are arranged symmetrically with respect to a centerline L2 of the handle 12 in a longitudinal direction Y of the handle 12 when viewed from the top. On the other hand, axes 303 of the roller unit shafts 30 in the other pair of roller units 203 and 204 are located on another virtual straight line L3 that is orthogonal to the longitudinal direction Y of the handle 12 at the other end side of the handle 12, and are arranged symmetrically with respect to the centerline L2 of the handle 12 in the longitudinal direction Y of the handle 12 when viewed from the top.

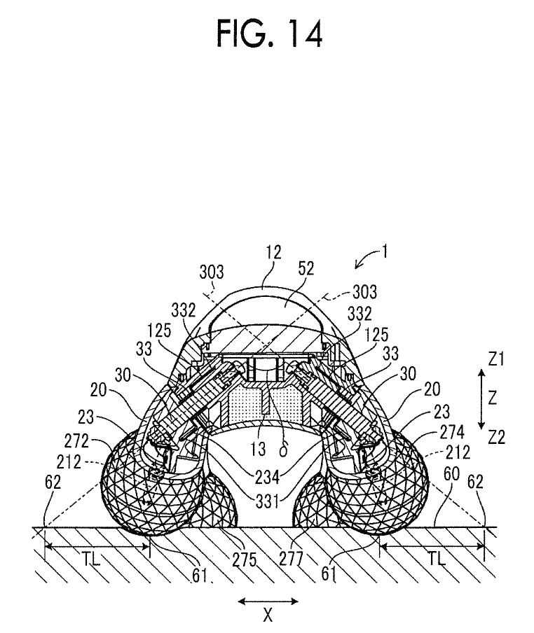

As illustrated in FIG. 14, in the beauty device 1 of this example, all of the roller units 201 to 204 are provided such that rollers 271 and 272 are located at a lower surface side Z2 opposite to an upper surface side Z1 at which light-receiving lenses 52 in the handle 12 are provided in a thickness direction Z that is orthogonal to the longitudinal direction Y and a transverse direction X of the handle 12. In this example, an angle δ formed by the axes 303 of the roller unit shafts 30 on the same plane S3 (see FIG. 13) is 100°.

Eight rollers 271 to 278 of the two pairs of roller units 201, 202, 203, and 204 are configured such that centers of gravity G1 and G2 thereof can be located on the same plane. When the eight rollers 271 to 278 are simultaneously brought into contact with outer skin 60, an excellent massage effect is obtained. Further, each of the eight rollers 271 to 278 in each of the roller units 201 to 204 rotates about the roller unit shaft 30, and thereby the eight rollers 271 to 278 can be adapted to encompass a greatly curved region of a body of a user. Thereby, the outer skin 60 of a shoulder or the like can be effectively massaged. In the beauty device 1 of this example, the same operation and effects as in the case of Examples 1 and 2 are exerted.

### Example 4

Another example of the beauty device will be described below.

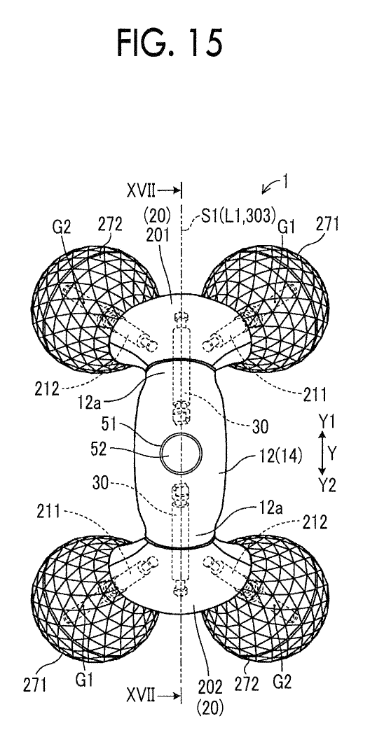

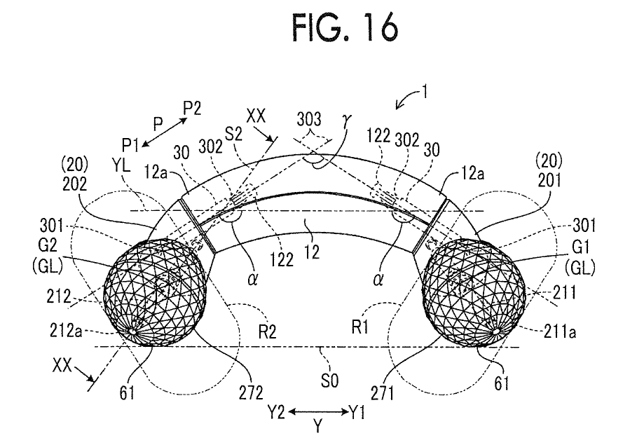

As illustrated in FIGS. 15 and 16, the beauty device 1 of Example 4 is a beauty device having four rollers 271 and 272 that are rotatable. The beauty device 1 includes a handle 12 and roller units 20 that are rotatably supported by the handle 12.

As illustrated in FIG. 15, the roller units 20 each include two rollers 271 and 272, and are configured such that, as illustrated in FIGS. 16 and 18, a rotational axis 303 of the roller unit 20 and a virtual straight line GL passing through both centers of gravity G1 and G2 of the two rollers 271 and 272 provided for the roller unit 20 are mutually located at positions skewed from each other. That is, the rotational axis 303 does not intersect the virtual straight line GL.

Hereinafter, the beauty device 1 of this example will be described in detail. The same constituent elements as in the above examples will be given the same reference signs, and description thereof will be omitted.

As illustrated in FIG. 15 to FIG. 18, a pair of roller units 201 and 202 mutually have the same structure.

In this example, the pair of roller units 201 and 202 can rotate within a range of −90° to 90° from the predetermined initial position. As illustrated in FIG. 16, a movable locus R1 in the first roller unit 201 and a movable locus R2 in the second roller unit 202 are spaced apart from each other. As a result, the movable ranges do not overlap.

As illustrated in FIG. 16, roller unit shafts 30 are located at the same side with respect to an axis YL of the handle 12 in the longitudinal direction Y of the handle 12 in a side view. With the approach from the proximal end 302 to the distal end 301 of each roller unit shaft 30, the roller unit shaft 30 is inclined with respect to the longitudinal direction Y of the handle 12 to face the distal end side Y1 of the handle 12 in the longitudinal direction of the handle 12. In this example, an angle α formed by the rotational axis 303 of the roller unit shaft 30 and the axis YL of the handle 12 in the longitudinal direction Y is 125°.

As illustrated in FIG. 15, the pair of roller units 201 and 202 are arranged symmetrically with respect to a virtual straight line L1 passing through the center of the handle 12 such that the rotational axes 303 of the roller unit shafts 30 are located on the same plane S1. As illustrated in FIG. 16, the rotational axes 303 of the pair of roller unit shafts 30 intersect each other at a portion at which the rotational axes 303 extend from the proximal ends 302 to sides opposite to the distal ends 301. Thereby, the pair of roller unit shafts 30 are provided in a tapered shape to be separated from each other with the approach from the proximal ends 302 to the distal ends 301. In this example, an angle α formed by the rotational axes 303 on the same plane S1 is 120°.

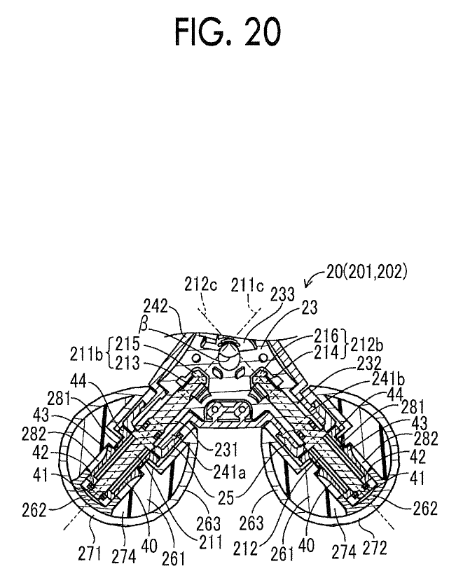

As illustrated in FIG. 18, when viewed in directions P of the rotational axes 303 of the roller unit shafts 30, the rotational axes 303 of the roller unit shafts 30 are located at positions separated from the virtual straight line GL passing through the centers of gravity G1 and G2 of the pair of rollers 271 and 272. That is, the rotational axes 303 and the virtual straight line GL are mutually located at positions skewed from each other. As illustrated in FIGS. 16 and 20, the centers of gravity G1 and G2 (see FIG. 15) of the four rollers 271 and 272 provided for the pair of roller units 201 and 202 are configured to be able to be located on the same plane.

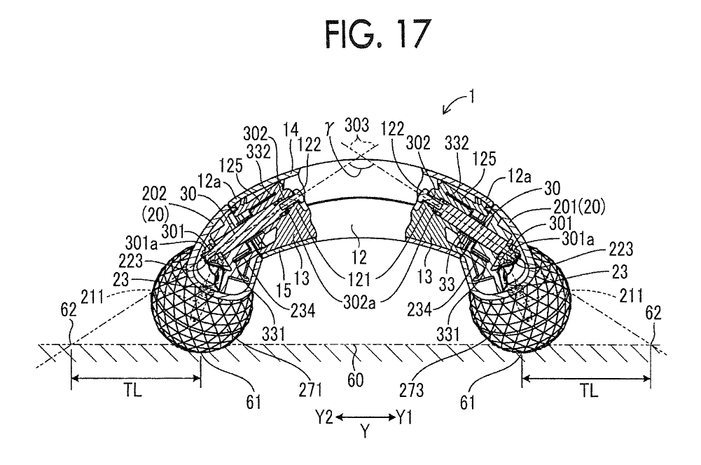

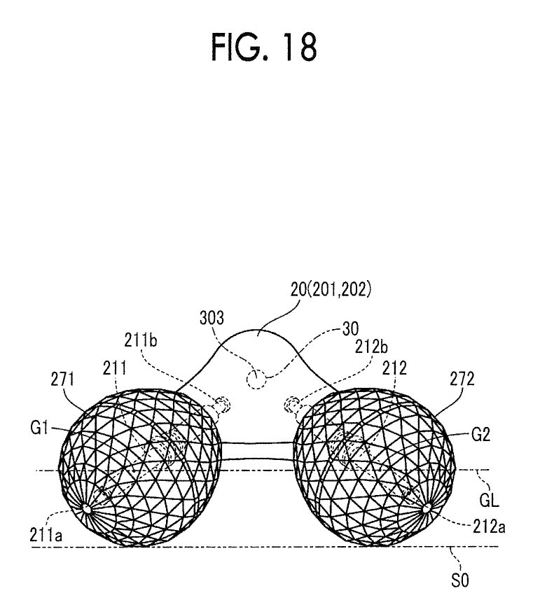

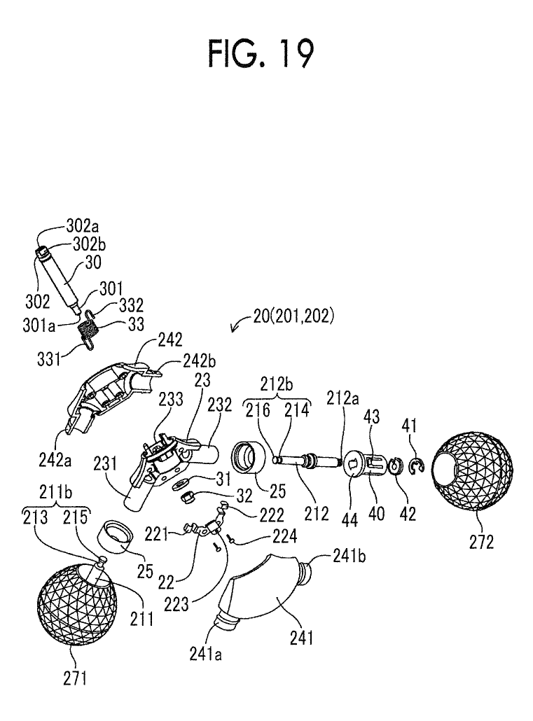

As illustrated in FIG. 15, like the above examples, a solar cell panel (not shown) is disposed at the base body 13 on an inner side of a light-receiving lens 52 (at an interior of the handle 12). Positive and negative output terminals of the solar cell panel are connected to a conductive part of an outer surface of the handle 12 and the roller unit shafts 30. Conduction from the roller unit shafts 30 to the rollers 271 and 272 is performed via shaft holders 22, roller shafts 211 and 212, and bearings 40 illustrated in FIGS. 19 and 20. As illustrated in FIG. 17, when the handle 12 and the rollers 271 and 272 touch the outer skin 60, a closed circuit is formed, and a weak current flows to the human body. Thereby, cells of the human body are stimulated and activated, and a beauty effect is obtained.

### Redescription

As illustrated in FIG. 17, the beauty device 1 of this example is used by moving the rollers 271 (272) in the longitudinal direction Y of the handle 12 in a state in which the handle 12 is grasped to bring the rollers 271 (272) into contact with the outer skin 60. In the outer skin 60, a distance between a center position 61 of a contact region with respect to each roller 271 and an intersection position 62 between the rotational axis 303 of each roller unit shaft 30 and the outer skin 60 becomes a trail length TL.

Next, an operation and effects in the beauty device 1 of this example will be described in detail.

According to the beauty device 1 of this example, the four rotatable rollers 271 and 272 are provided, and the roller unit 201 (202) for which the two rollers 271 and 272 among them are supported by the handle 12 to be rotatable about the rotational axis 303. For this reason, a positional relation between the pair of rollers 271 and 272 provided for the same roller unit 201 (202) among the four rollers 271 and 272 is fixed, but a positional relation between the pair of rollers 271 and 272 and the other rollers (the rollers 271 and 272 of the other roller unit 202 (201)) can be changed by rotation of the roller unit 201 (202). For this reason, a massaging mode is not uniform, and thus it is possible to inhibit a user from getting tired of the beauty device 1 even with repeated use.

Further, since the positional relation between the four rollers 271 and 272 in the different roller units 201 and 202 can be changed by the rotation of the roller unit 201 (202), the rollers 271 and 272 easily follow the outer skin 60 to be curved without greatly twisting the wrist of a hand grasping the beauty device 1, and use becomes easier. Thereby, the beauty device is easily used in various regions of the body.

For example, when the beauty device having a conventional configuration is in use and the handle is grasped by a right hand for treatment of a left side, the beauty device should be set in a state in which the wrist is greatly twisted to erect the handle with respect to the outer skin in order to apply the rollers to the outer skin. However, according to the beauty device 1 of this example, even when the handle is grasped by a right hand for treatment of a left side, the roller units 201 and 202 are rotated. Thereby, without greatly twisting the wrist to erect the handle 12 with respect to the outer skin 60, the treatment can be performed by applying the rollers 271 and 272 to the outer skin 60. Thereby, use becomes easier.

In this example, the roller units 201 and 202 are provided in a pair. Thereby, since the pair of roller units 201 and 202 are rotatable relative to the handle 12, the four rollers 271 and 272 easily change the mutual positional relation to follow the outer skin 60. Thereby, without twisting the wrist or greatly inclining the handle 12 during use, the rollers 271 and 272 can be used in the various regions of the body, and the followability of the rollers 271 and 272 to the outer skin 60 can be further improved. The rollers 271 and 272 are more easily used in the various regions of the body.

In this example, the roller units 201 and 202 include the pair of roller shafts 211 and 212 that rotatably support the rollers 271 and 272 by means of the distal ends 211a and 212a thereof and are provided in a tapered shape. Thereby, since the rotational axes 303 of the rollers 271 and 272 are disposed in a tapered shape, when the rotational axes 303 of the pair of rollers 271 and 272 are forwardly inclined with respect to the traveling direction, the rollers 271 and 272 are rotated to forcibly spread surrounding skin downward on the outer skin 60, and thereby the outer skin 60 can be pressed. When backwardly inclined, the rollers 271 and 272 are rolled up to lift the surrounding skin upward on the outer skin 60, and thereby the outer skin 60 can be picked up, and the excellent massage effect is exerted. Further, in the picked-up state, the close-contact characteristic between the rollers 271 and 272 and the outer skin is further improved, and thus the state in which the rollers 271 and 272 and the outer skin 60 are in close contact with each other is easily maintained. As a result, when the beauty device 1 is moved along the outer skin 60, followability of the rollers 271 and 272 is improved.

In this example, the rotational axes 303 in the pair of roller units 201 and 202 are located on the same plane S1. Thereby, the pair of roller units 201 and 202 rotate about the rotational axes 303 located on the same plane S1, and thus the rollers 271 and 272 easily follow the outer skin 60.

In this example, the rotational axes 303 in the pair of roller units 201 and 202 are provided in a state in which they extend from the handle 12 in a tapered shape. That is, the pair of roller unit shafts 30 are arranged to be separated from each other as the ends thereof at the sides connected to the handle 12 approach from the proximal ends 302 thereof to the distal ends 301 thereof connected to the roller units 201 and 202. Thereby, when the beauty device 1 is moved along the outer skin 60, the skin can be picked up by the two rollers 271 and 272 in the roller unit 202 (201) of the pair of roller units 201 and 202 which is located at a rear side in the traveling direction while the skin is being pressed by the two rollers 271 and 272 in the roller unit 201 (202) at a front side in the traveling direction. Thereby, since both actions of the pressing and the picking up of the skin occur with simple movement in one direction, the skin is effectively massaged to exert the excellent massage effect.

In this example, among the four rollers 271 and 272, the rollers 271 and 272 provided for the roller units 201 and 202 that are different from each other are configured such that the mutual movable loci R1 and R2 are separated from each other. Thereby, the neighboring rollers are prevented from coming into contact with each other between the roller units 201 and 202 that are different from each other. As a result, a space between the neighboring rollers between the roller units 201 and 202 that are different from each other is unintentionally narrowed, and thereby pinching of the skin can be suppressed. Further, in a state in which the four rollers 271 and 272 are simultaneously in contact with the skin, the handle 12 is rotated relative to the roller unit shaft 30, and thereby the roller units 201 and 202 are pushed out along the handle 12. Thereby, the roller units 201 and 202 are rotated, and an interval between the rollers is changed between the roller units 201 and 202 that are different from each other. The interval of one set of neighboring rollers between the roller units 201 and 202 that are different from each other is reduced, and the rollers come close to each other. Further, the interval of the other set of rollers is increased, and the roller are moved away from each other. In this way, the interval between the rollers between the roller units 201 and 202 that are different from each other is changed, and thereby a kneading action caused by the roller units 201 and 202 can be performed.

In this example, the four rollers 271 and 272 are configured to be able to be in contact on the same plane S0 at the same time. Thereby, the four rollers 271 and 272 are reliably in contact with the skin, and the massage effect can be exerted.

According to the beauty device 1 of this example, when viewed in the direction P of the rotational axes 303, the centers of gravity G1 and G2 of the rollers 271 and 272 are located at positions shifted from the rotational axes 303. When the four rollers 271 and 272 come in contact with the outer skin 60, the trail length TL is naturally made large. For this reason, since the rectilinear stability of the rollers 271 and 272 is improved, the rollers 271 and 272 are easily made to go straight along the outer skin 60 directed in various directions. Thereby, use becomes easy, and a feeling of use is improved.

In this example, the pair of roller units 201 and 202 are made up of the first roller unit 201 and the second roller unit 202 that have completely the same configuration. However, instead of this, the pair of roller units 201 and 202 may be made up of two roller units that can be recognized as configurations that are not completely the same but are similar to each other within a range in which the above operation and effects are exerted. For example, in each of the roller units, the rollers 271 and 272 may be different in diameter, or the rollers 271 and 272 may be different in length.

As described above, according to this example, the beauty device 1 which a user does not easily get tired of even with repeated use, and which can be used in the various regions of the body and is easy to use can be provided.

### Example 5

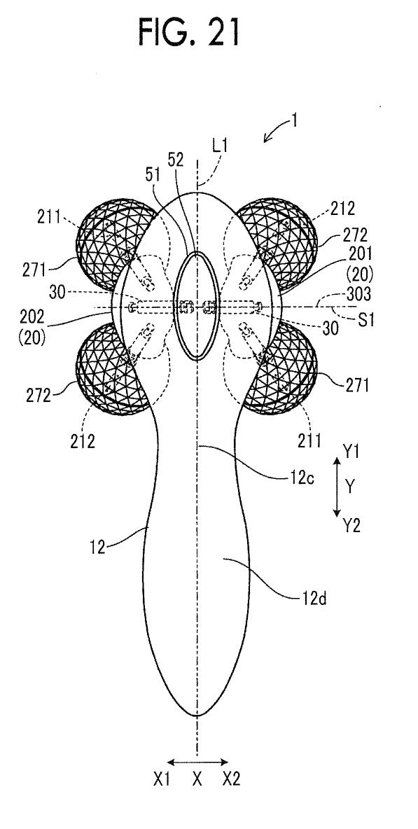

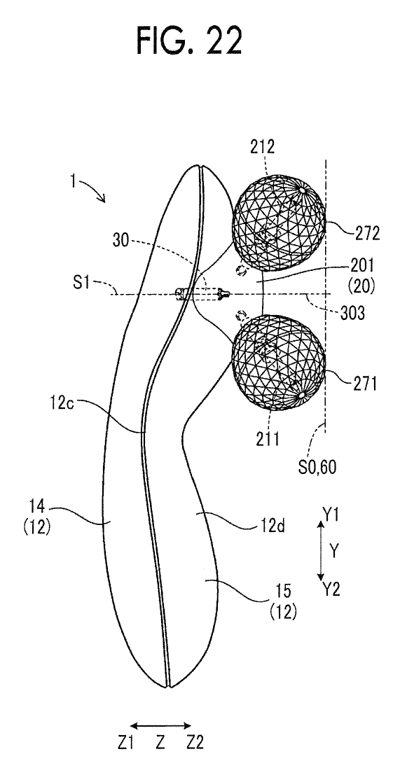

In the beauty device 1 of Example 5, as illustrated in FIGS. 21 to 23, a pair of roller units 201 and 202 are provided at a side that is a first end side Y1 relative to a midsection 12c in a longitudinal direction Y of a handle 12 and is opposite to a side at which a light-receiving lens 52 (see FIG. 21) is provided in a thickness direction Z as illustrated in FIG. 22. The same constituent elements as in Example 4 will be given the same reference signs, and description thereof will be omitted.

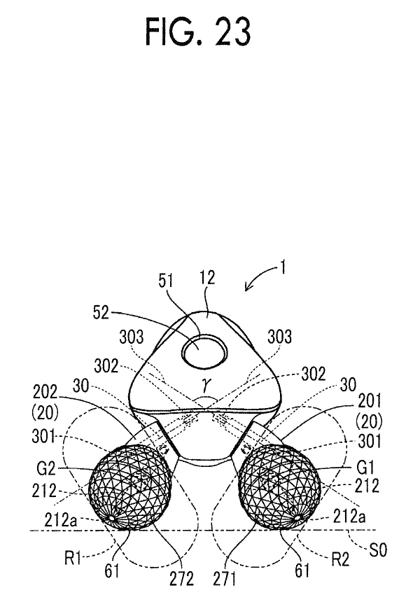

As illustrated in FIG. 21, rotational axes 303 of roller units 20 are arranged symmetrically with respect to a virtual straight line L1 passing through the center of the handle 12 to be located on the same plane S0. As illustrated in FIGS. 22 and 23, four rollers 271 and 272 provided for the pair of roller units 201 and 202 are configured to be able to come into contact with the same plane S0 at the same time. As illustrated in 23, in this example, in the pair of roller units 201 and 202, the rotational axes 303 intersect each other at a portion that is located from proximal ends 302 to sides opposite to distal ends 301 and form an angle α of 120°. In this example, as illustrated in FIG. 21, when viewed from the top, the plane S0 and the virtual straight line L1 are orthogonal to each other.

In this example, as illustrated in FIGS. 21 and 22, the handle 12 is constricted at the midsection 12c, and is formed with a grasping part 12d configured such that a portion of a second end side Y2 is more easily grasped than the midsection 12c.

According to the beauty device 1 of this example, the pair of roller units 201 and 202 are provided at the first end side Y1 relative to the midsection 12c of the handle 12, and the grasping part 12d is formed at the second end side Y2 relative to the midsection 12c of the handle 12. Thus, the four rollers 271 and 272 are easily moved along outer skin 60 with the grasping part 12d grasped, and manipulability is good. In addition, since the grasping part 12d is not located between the roller units 201 and 202, there is no need to consider, for instance, a hand of a user entering between the roller units 201 and 202 to make it possible to grasp the grasping part 12d. For this reason, an interval between the roller units 201 and 202 can be made narrower than a width of the hand of the user. As a result, the interval between the rollers can be reduced, and treatment caused by the four rollers 271 and 272 can be applied to a narrow range of the outer skin 60. In this example, the same operation and effects as in Example 4 are exerted.

Further, according to the beauty device 1 of this example, as illustrated in FIG. 22, in a state in which the four rollers 271 and 272 are applied to the outer skin 60, a wrist grasping the grasping part 12d is twisted to an upper surface side Z1 in the thickness direction Z, and thereby the beauty device 1 is inclined to the first end side Y1 in the longitudinal direction Y. An interval (see FIG. 21) between the rollers 271 and 272 located at the first end side Y1 in the longitudinal direction Y can be narrowed, and an interval between the rollers 271 and 272 located at the second end side Y2 in the longitudinal direction Y can be widened. On the other hand, the wrist grasping the grasping part 12d is twisted to a lower surface side Z2 in the thickness direction Z, and thereby the beauty device 1 is inclined to the second end side Y2 in the longitudinal direction Y. The interval (see FIG. 21) between the rollers 271 and 272 located at the first end side Y1 in the longitudinal direction Y can be widened, and the interval between the rollers 271 and 272 located at the second end side Y2 in the longitudinal direction Y can be narrowed. Therefore, an action of twisting the wrist grasping the grasping part 12d to the upper surface side Z1 in the thickness direction Z and an action of twisting the wrist to the lower surface side Z2 are repetitively performed. Thereby, the skin between the narrowed rollers 271 and 272 can be picked up, and the skin between the widened rollers 271 and 272 can be spread out. The skin can be massaged in a kneading motion.

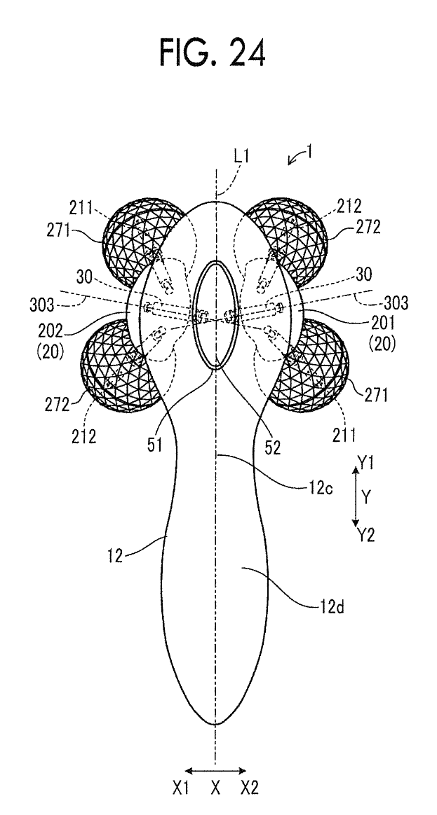

In this example, as illustrated in FIG. 21, when viewed from the top, the rotational axes 303 of the pair of roller unit shafts 30 are configured to be located on the plane S0 that is orthogonal to the virtual straight line L1. However, instead of this, the configuration may be set as in Modification 2 illustrated in FIG. 24. That is, as illustrated in FIG. 24, in Modification 2, when viewed from the top, the rotational axes 303 of the pair of roller unit shafts 30 intersect each other. In this case, since pressing and massaging intensities occurring between the rollers 271 and 272 located at the first end side Y1 in the longitudinal direction Y in the pair of roller units 201 and 202 are different from those occurring between the rollers 271 and 272 located at the second end side Y2, a user obtains different bodily sensations, a massage effect is further enhanced, and the user does not get tired of the device even with repeated use.

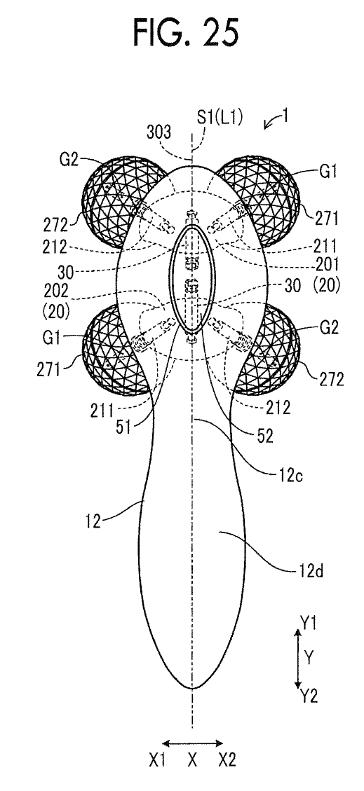

Further, in Example 5, as illustrated in FIG. 21, when viewed from the top, the rotational axes 303 of the pair of roller units 20 are configured to be located on the plane S0 intersecting the virtual straight line L1. However, instead of this, the configuration may be set as in Modification 3 illustrated in FIG. 25. In Modification 3, as illustrated in FIG. 25, when viewed from the top, the rotational axes 303 of the pair of roller units 20 are configured to be located on the virtual straight line L1, and the plane S0 and the virtual straight line L1 overlap each other.

Further, according to the beauty device 1 of Modification 3, in a state in which the four rollers 271 and 272 are applied to the outer skin 60, a wrist grasping the grasping part 12d is twisted to one side X1 in a transverse direction X, and thereby the beauty device 1 is inclined to the one side X1 in the transverse direction X. An interval (see FIG. 25) between the rollers 271 and 272 located at the one side X1 in the transverse direction X can be narrowed, and an interval between the rollers 271 and 272 located at the other side X2 in the transverse direction X can be widened. On the other hand, the wrist grasping the grasping part 12d is twisted to the other side X2 in the transverse direction X, and thereby the beauty device 1 is inclined to the other side X2 in the transverse direction X. The interval (see FIG. 25) between the rollers 271 and 272 located at the one side X1 in the transverse direction X can be widened, and the interval between the rollers 271 and 272 located at the other side X2 in the transverse direction X can be narrowed. Therefore, an action of twisting the wrist grasping the grasping part 12d to the one side X1 in the transverse direction X and an action of twisting the wrist to the other side X2 are repetitively performed. Thereby, the skin between the narrowed rollers 271 and 272 can be picked up, and the skin between the widened rollers 271 and 272 can be spread out. The skin can be massaged in a kneading motion. In such a use mode in Modification 3, to perform the twisting action in the transverse direction X, in comparison with the twisting action in the longitudinal direction Y in the case of Example 5, an action of an arm associated with the twisting action can be reduced. Thereby, the massage can be performed with a small action. In addition, in Modification 3, the same operation and effects as in the case of Example 5 are exerted.

### Example 6

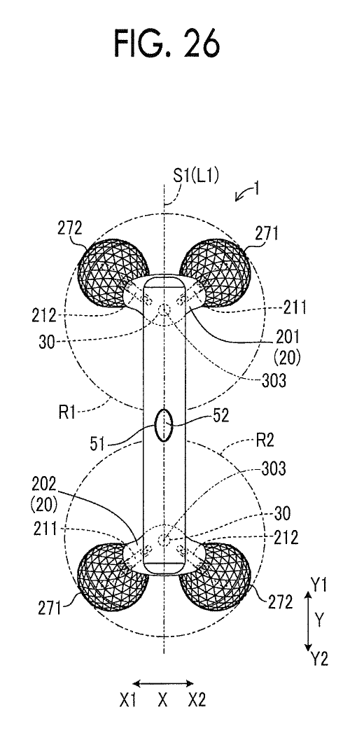

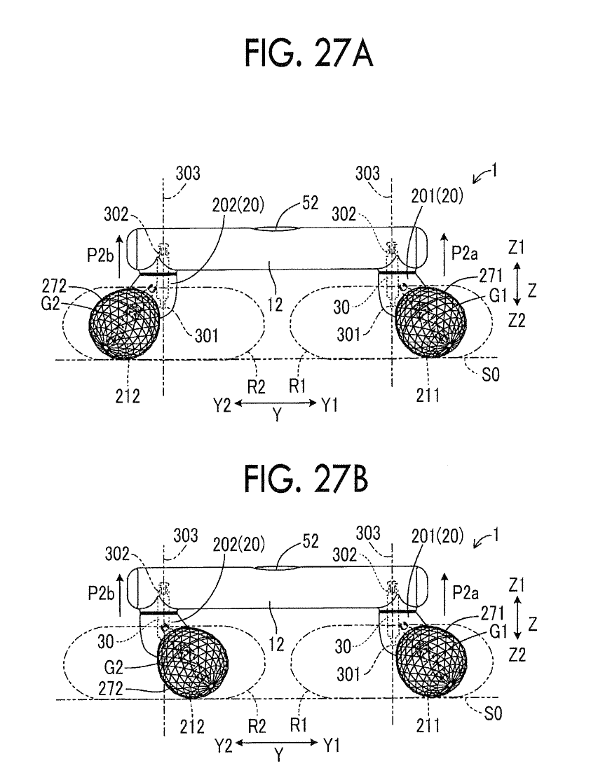

As illustrated in FIGS. 26 and 27(a), in the beauty device 1 of this example, a handle 12 has a columnar shape. A light-receiving lens 52 is provided at a midsection 12c on a side circumferential surface of the handle 12 in a longitudinal direction Y of the handle 12, and a pair of roller units 201 and 202 are provided at opposite end sides Y1 and Y2 in the longitudinal direction Y. The pair of roller units 201 and 202 are provided at a side opposite to the light-receiving lens 52 in a thickness direction Z. As illustrated in FIG. 27A, in roller unit shafts 30 of the pair of roller units 201 and 202, directions P1a and P1b directed from proximal ends 302 to distal ends 301 become the same direction. Thereby, the pair of roller units 201 and 202 are provided in a state in which rotational axes 303 thereof extend from the handle 12 in parallel to each other in the same direction. The rotational axes 303 in the pair of roller units 20 are perpendicular to the longitudinal direction Y. The same constituent elements as in Example 4 will be given the same reference signs, and description thereof will be omitted.

In this example, all of the pair of roller units 201 and 202 can be freely rotated about the rotational axes 303, respectively, and are configured to be at least rotatable at 360° with no limitation to a rotational range thereof. Thereby, the roller units 201 and 202 can be at least rotated one or more turn, and use becomes still easier. As illustrated in FIG. 26, even in the case of this example, movable loci R1 and R2 of the rollers 271 and 272 in the pair of roller units 201 and 202 are separated and do not overlap each other.

According to the beauty device 1 of this example, the rotational axes 303 in the pair of roller units 20 extend from the handle 12 in parallel to each other in the same direction. Since the roller units 201 and 202 can be rotated around the rotational axes 303 respectively, the rollers 271 and 272 can be used in any of a state in which they are located at a front side from the roller unit shafts 30 in a traveling direction and a state in which they are located at a rear side in a traveling direction. In the state in which the rollers 271 and 272 are located at the front side in the traveling direction, a pressing action of skin is obtained. In state in which the rollers 271 and 272 are located at the rear side in the traveling direction, a picking-up action of the skin is obtained. Therefore, a user rotates the roller units 201 and 202 around the rotational axes 303 when in use, and selects any one of the two states. Thereby, pressing or picking up can be selected. As a result, a bodily sensation suitable for a taste of the user is easily obtained. Since the two states can be easily switched by simply rotating the roller units 201 and 202, the use becomes easier, and the user is more difficult to get tired of the device even with repeated use.

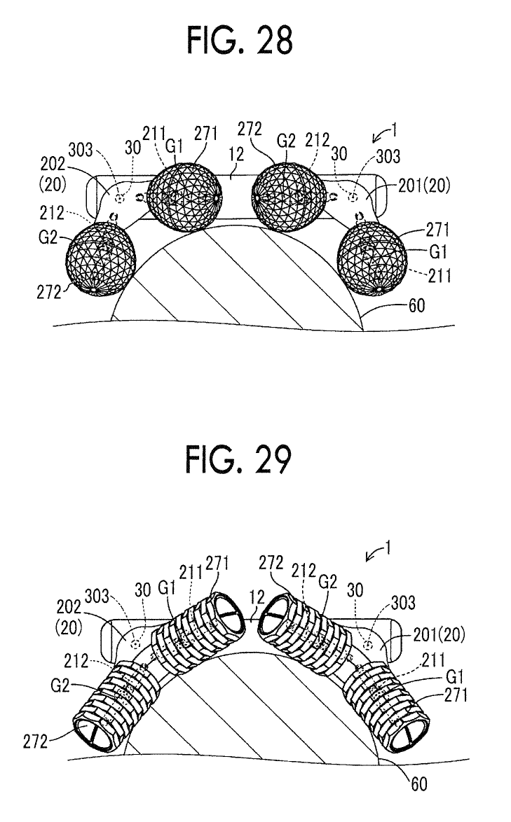

According to the beauty device 1 of this example, the directions of the roller units 201 and 202 are changed. Thereby, an arbitrary use mode can be selected from a first use mode shown in FIG. 27A, a second use mode shown in FIG. 27A, and a third use mode shown in FIG. 28.

In the first use mode, as illustrated in FIG. 27A, the pair of rollers 271 and 272 provided for the first roller unit 201 are located at the first end side Y1 from the rotational axis 303 of the first roller unit 201, and the pair of rollers 271 and 272 provided for the second roller unit 202 are located at the second end side Y2 from the rotational axis 303 of the second roller unit 202. In this case, the beauty device 1 is moved to the first end side Y1 or the second end side Y2 along the outer skin. Thereby, the skin can be pressed by the pair of rollers 271 and 272 at the front side in the traveling direction, and the skin can be picked up by the pair of rollers 271 and 272 at the rear side in the traveling direction.

Although not illustrated, the pair of rollers 271 and 272 provided for the first roller unit 201 are located at the second end side Y2 from the rotational axis 303 of the first roller unit 201, and the pair of rollers 271 and 272 provided for the second roller unit 202 are located at the first end side Y1 from the rotational axis 303 of the second roller unit 202. This case is also the same as in the first use mode.

In the second use mode, as illustrated in FIG. 27B, the pair of rollers 271 and 272 provided for the first roller unit 201 and the second roller unit 202 are located at the first end side Y1 from the rotational axes 303. In this case, the beauty device 1 is moved to the first end side Y1 along the outer skin, and thereby the skin can be pressed by the rollers 271 and 272 in the pair of roller units 201 and 202. The beauty device 1 is moved to the second end side Y2, and thereby the skin can be picked up by the rollers 271 and 272 in the pair of roller units 201 and 202.

Although not illustrated, in a state in which the pair of rollers 271 and 272 provided for the first roller unit 201 and the second roller unit 202 are located at the second end side Y2 from the rotational axes 303 of the first and second roller units, the beauty device 1 is moved to the first end side Y1 along the outer skin, and thereby the skin can be picked up by the rollers 271 and 272 in the pair of roller units 201 and 202. The beauty device 1 is moved to the second end side Y2, and thereby the skin can be pressed by the rollers 271 and 272 in the pair of roller units 201 and 202.

In the third use mode, as illustrated in FIG. 28, in the pair of roller units 201 and 202, when viewed in the thickness direction Z, in a state in which the centers of gravity G1 and G2 of the rollers 271 and 272 are located closer to the outer skin 60 than the rotational axes 303, the four rollers 271 and 272 are is contact with the outer skin 60. In this case, the outer skin 60 is in a state in which it is encompassed by the four rollers 271 and 272. At this point, when one of the pairs of rollers 271 and 272 provided for the roller units 201 and 202 receives a reaction force from the outer skin 60 to rotate the roller units 201 and 202, the other roller is rotated in a direction applied to the skin. As a result, a close-contact degree between the rollers 271 and 272 and the outer skin 60 is improved. The four rollers 271 and 272 follow the outer skin 60, and the beauty device 1 is moved to an upper surface side Z1 (a deep side of the sheet of FIG. 28) in the thickness direction Z, and thereby the skin can be picked up by the rollers 271 and 272 in the pair of roller units 201 and 202. The beauty device 1 is moved to a lower surface side Z2 (a front side of the sheet of FIG. 28), and thereby the skin can be pressed by the rollers 271 and 272 in the pair of roller units 201 and 202. The third use mode is especially effective for the outer skin 60 having a relatively great curvature. In the third use mode, with intent to only press the outer skin 60, in a state in which the four rollers 271 and 272 are in contact with the outer skin 60, the rotation of the rollers 271 and 272 may be locked and used.

The rollers 271 and 272 may be formed in an approximately columnar shape as in Modification 4 illustrated in FIG. 29. In this case, the same operation and effects as in this example are exerted. Especially, as illustrated in FIG. 29, when the aforementioned third use mode is selected and used in a state in which the four rollers 271 and 272 encompass the outer skin 60, the rollers 271 and 272 are formed in an approximately columnar shape, and thereby a contact area between the rollers 271 and 272 and the outer skin 60 is further increased, and a sweeping effect with respect to a wide range of the skin is obtained.

### Example 7

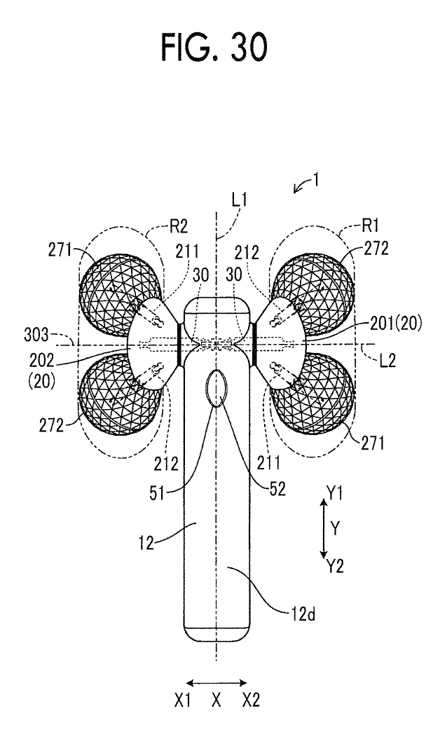

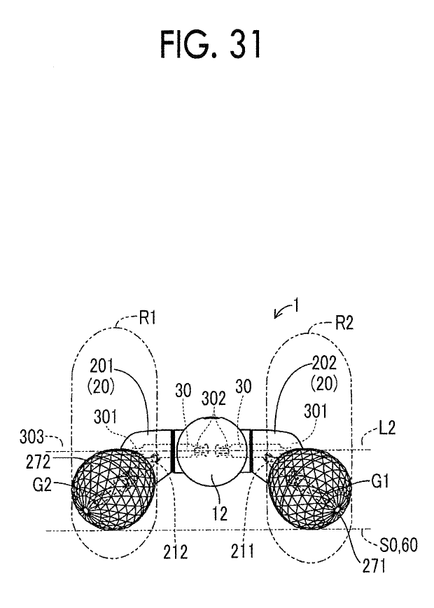

In Example 6 above, as illustrated in FIG. 26, the pair of roller units 201 and 202 are provided on the side circumferential surfaces of the opposite end sides Y1 and Y2 of the handle 12. As illustrated in FIGS. 30 and 31, in the beauty device 1 of this example, a pair of roller units 201 and 202 are provided on a side circumferential surface of a first end side Y1 of a handle 12. A pair of roller unit shafts 30 are located on the same straight line L2.

According to the beauty device 1 of this example, as illustrated in FIGS. 30 and 31, rotational axes 303 in a pair of roller units 20 are located on the same straight line L2, and the pair of roller units 201 and 202 are mutually directed in the opposite directions. Thereby, when the beauty device 1 moves four rollers 271 and 272 along a outer skin 60, the pair of roller units 201 and 202 are individually easily rotated according to the outer skin 60, and thus the rollers 271 and 272 more easily follow the outer skin 60. As a result, a user need not excessively twist a wrist to bring the rollers 271 and 272 into contact with the outer skin 60, and thus use becomes easier, and a bodily sensation of the user is also improved. Even in this case, when the beauty device 1 is moved along the outer skin, the skin can be picked up by the two rollers 271 and 272 in the roller unit 202 (201) at a rear side in a traveling direction among the pair of roller units 201 and 202 while pressing the skin with the two rollers 271 and 272 in the roller unit 201 (202) at a front side in the traveling direction. Thereby, since both actions of the pressing and the picking up of the skin by simply movement in one direction occur, the skin is effectively massaged to exert an excellent massage effect.

According to the beauty device 1 of this example, the rotational axes 303 in the pair of roller units 20 are located on the same straight line L2, and the rotational axes 303 are perpendicular to a longitudinal direction Y. Thereby, when the beauty device 1 is moved along the outer skin, although an inclined degree of the beauty device 1 in the longitudinal direction Y is changed, angles of the pair of roller unit shafts 30 with respect to the outer skin are not changed, and an interval between the rollers 271 and 272 is also not changed. For this reason, when used on the outer skin directed in various directions, the beauty device 1 can be stably moved along the outer skin, and followability to the outer skin is further enhanced.

### Example 8

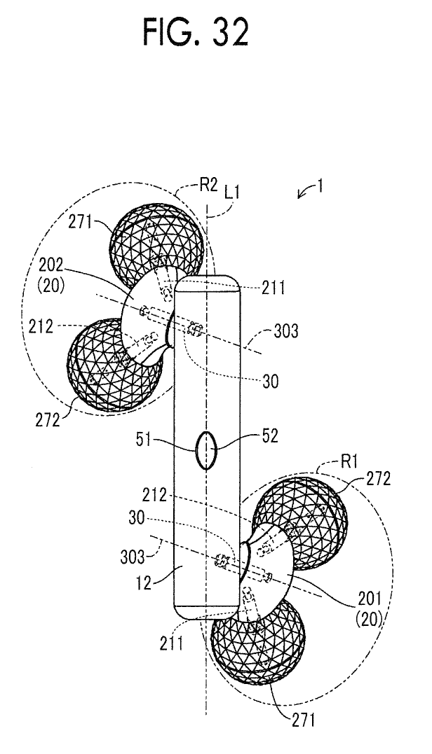

In the beauty device 1 of this example, as illustrated in FIG. 32, a first roller unit 201 is provided at a first end side Y1 on a side circumferential surface of a columnar handle 12, and a second roller unit 202 is provided at a second end side Y2 on the side circumferential surface. A rotational axis 303 of the first roller unit 201 and a rotational axis 303 of the second roller unit 202 are located at positions skewed from each other.

According to the beauty device 1 of this example, as illustrated in FIG. 32, the pair of roller units 201 and 202 do not intersect each other, and are rotated about the rotational axes 30 that are not parallel, and thus a user can obtain different bodily sensations through the pair of roller units 201 and 202. Thereby, a user does not easily get tired of the device even with repeated use.

### Example 9

An example of the beauty device will be described below.

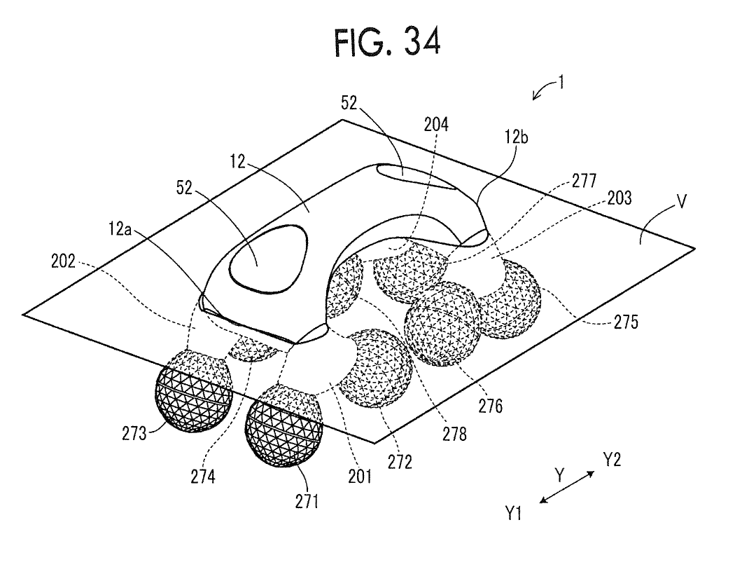

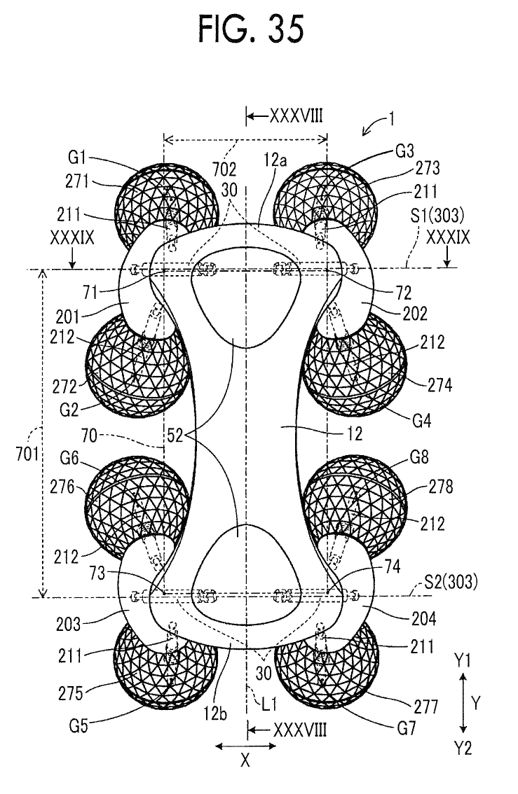

As illustrated in FIGS. 34 and 35, the beauty device 1 of Example 9 has a handle 12, roller supports 201, 202, 203, and 204, and rollers 271, 272, 273, 274, 275, 276, 277, and 278.

Four roller units (hereinafter referred to as “roller supports”) 201 to 204 are provided, and are rotatably supported by the handle 12.

The rollers 271 to 278 are rotatably supported by the roller supports 201 to 204 two by two.

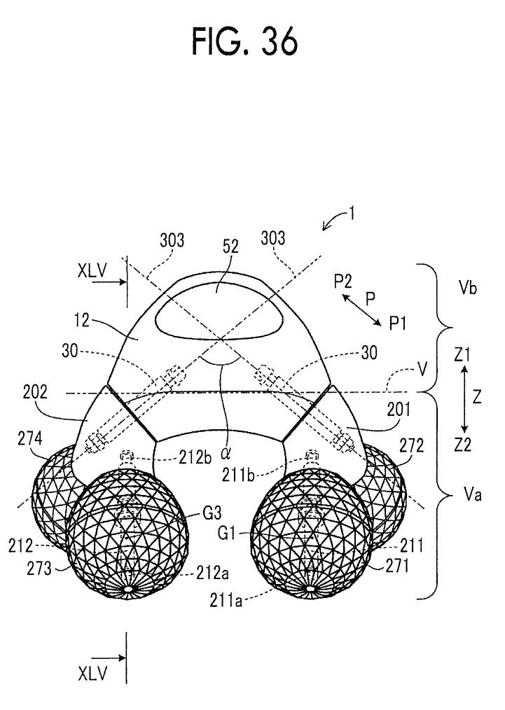

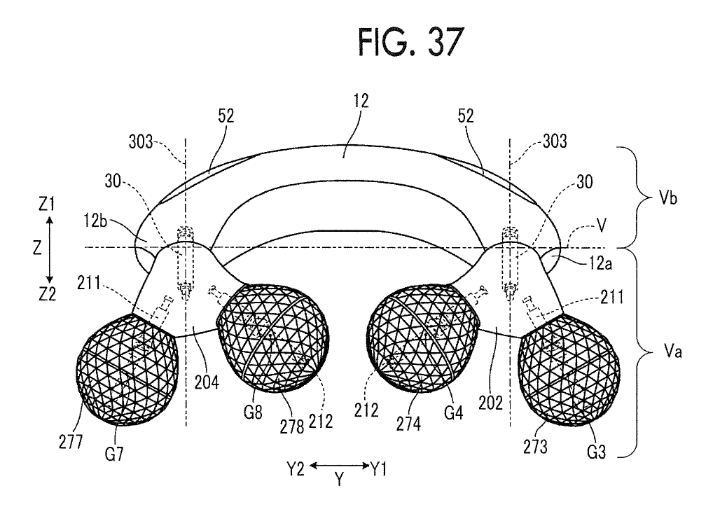

As illustrated in FIGS. 36 and 37, the rollers 271 to 278 are located at a lower side Z2 from the handle 12.

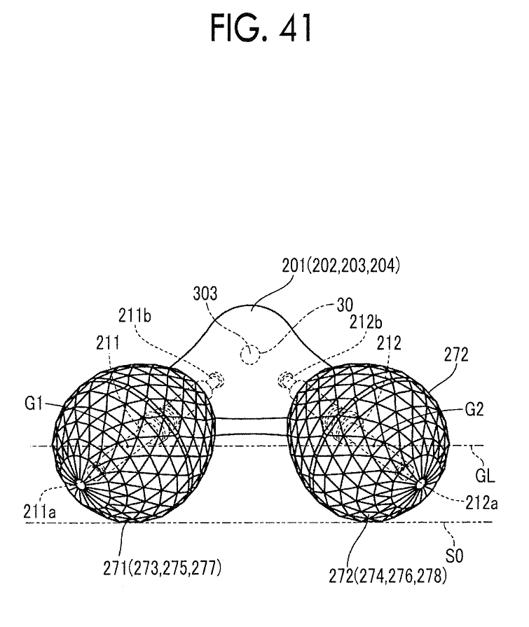

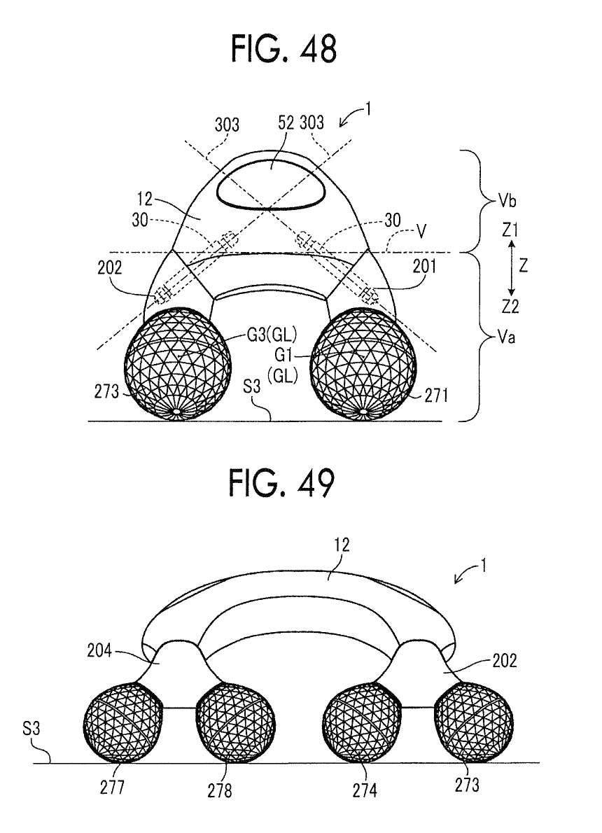

As illustrated in FIGS. 41 and 48, in the roller supports 201 to 204, rotational axes 303 with respect to the handle 12 and a virtual straight line GL passing through both of the centers of gravity G1 and G2 of the two rollers 271 and 272 are configured to be located at positions skewed from each other.

As illustrated in FIG. 36, when viewed from a predetermined lateral side Y2, in at least two neighboring roller supports 201 and 202, the rotational axes 303 are spaced apart from each other with the approach from the handle 12 to the lower side Z2.

In this example, as illustrated in FIGS. 34 and 36, a plane passing through all of the roller supports 201 to 204 is defined as a virtual reference plane V, a direction from the virtual reference plane V to one region Va of regions bisected by the virtual reference plane V is defined as a lower side Z2, and a direction directed to the other region Vb is defined as an upper side Z1. In this example, as illustrated in FIG. 35, a longitudinal direction of the handle 12 is defined as Y, a direction directed from the center to a first end 12a in the longitudinal direction Y is defined as one end direction Y1, and a direction directed to the second end 12b is defined as the other end direction Y2. As illustrated in FIG. 34, the virtual reference plane V is parallel to the longitudinal direction Y of the handle 12, and the other end direction Y2 in the longitudinal direction Y is defined as a predetermined lateral side.

Hereinafter, the beauty device 1 of this example will be described in detail. The same constituent elements as in the aforementioned examples will be given the same reference signs, and description thereof will be omitted.

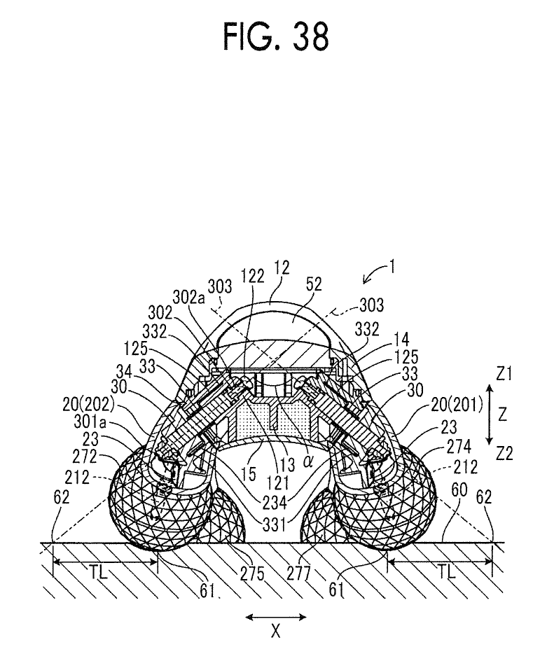

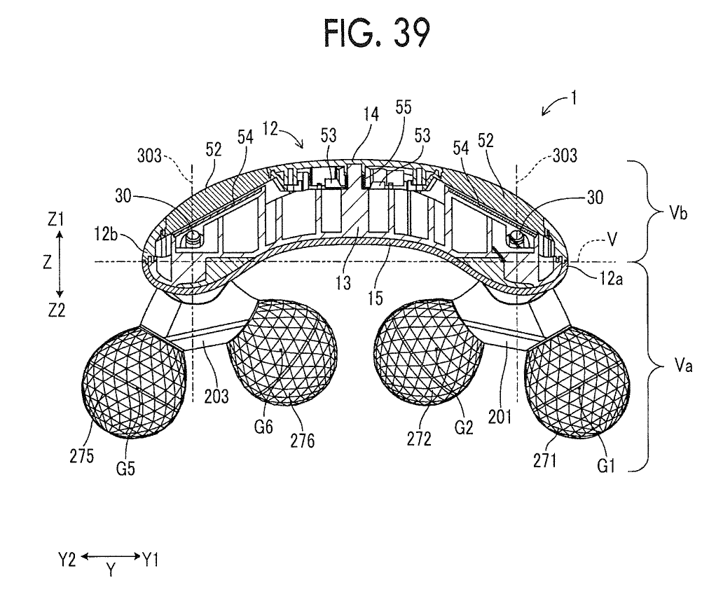

As illustrated in FIGS. 34, 35 and 37, the beauty device 1 includes the handle 12 having an approximate rod shape. In this example, as illustrated in FIGS. 38 and 39, the handle 12 includes a base body 13, a first cover body 14, and a second cover body 15 in the same way as in the aforementioned examples. Further, greases 151 and 152 are provided inside the second cover body 15 at an end in the one end direction Y1 and an end in the other end direction Y2.

In this example, as illustrated in FIG. 37, the handle 12 is bent in an arch shape to protrude to the upper side Z1. As illustrated in FIG. 35, a width (a length in the transverse direction X) of the handle 12 is reduced in the longitudinal direction Y with the approach from the vicinities of the first and second ends 12a and 12b at which the roller supports 201 and 202 are provided to the center. Thereby, the midsection of the handle 12 is easily grasped. As the center of the handle 12 is grasped, a hand grasping the handle 12 is prevented from interfering with the roller supports 201 to 204 and the rollers 271 to 278, and the easy-to-use is obtained. To prevent a slip of the hand grasping the handle 12, non-slip protrusions or fine irregularities may be provided on a surface of the handle 12, or an anti-slip member formed of a rubber or the like may be provided at at least a part of the surface of the handle 12.

As illustrated in FIGS. 34, 35 and 37, the pair of roller supports 201 and 202 are provided at the first end 12a of the handle 12 in the longitudinal direction Y, and the pair of roller supports 203 and 204 are provided at the second end 12b of the handle 12 in the longitudinal direction Y. As illustrated in FIG. 35, the four roller supports 201 to 204 are located at apexes 71, 72, 73, and 74 of a virtual rectangle 70 having long and short sides 701 and 702 on the virtual reference plane V.

As illustrated in FIG. 35 to FIG. 41, the roller supports 201 to 204 have structures identical to one another. As illustrated in FIG. 41, the two rollers 271 and 272 are rotatably provided for the first roller support 201 via a pair of roller shafts 211 and 212. A roller unit 20 is formed by the two rollers 271 and 272, the roller shafts 211 and 212, and the roller support 201. Similarly, two of the rollers 273 to 278 are rotatably provided for each of the roller supports 202 to 204 via the pair of roller shafts 211 and 212, and the roller unit 20 is formed by two of the rollers 273 to 278, the roller shafts 211 and 212, and each of the roller supports 202 to 204.

As illustrated in FIGS. 34 and 35, the rollers 271 to 278 are formed in a shape in which a spherical shape is slightly stretched, and have substantially a spherical shape. The spherical shape used herein is referred to as a spherical shape inclusive of such a shape. As illustrated in FIGS. 36 and 37, all of the rollers 271 to 278 are located at the lower side Z2 from the handle 12 when each of the roller supports 201 to 204 is at least located at an initial position.

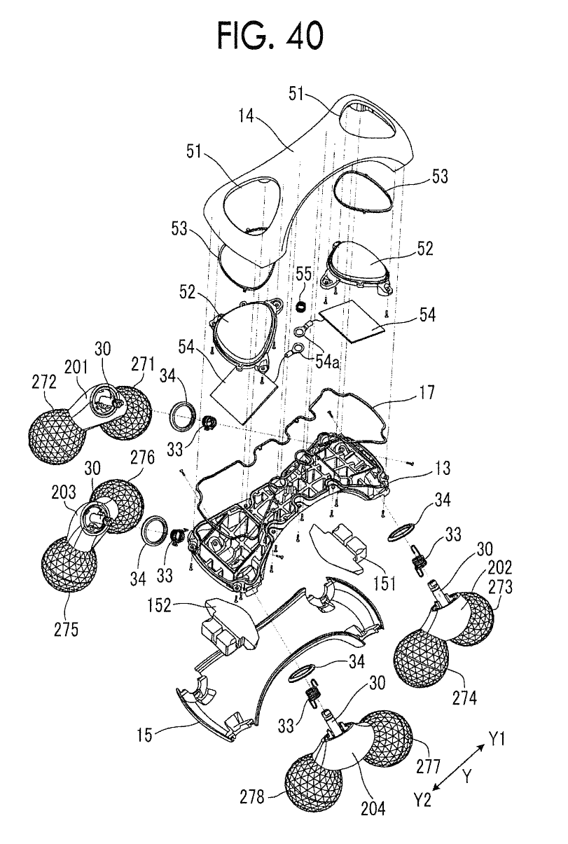

As illustrated in FIG. 41, in the roller support 201, the rollers 271 and 272 are configured in the same way as in the aforementioned examples, and a so-called diamond cut by which numerous triangular planes are continuously formed is performed on outer circumferential surfaces of the rollers 271 and 272. As illustrated in FIG. 40, in the other roller supports 202 to 204, the rollers 273 to 278 are configured to be identical to the rollers 271 and 272.

In this example, as illustrated in FIG. 35, among the four roller supports 201 to 204, the roller supports 201 and 202 are rotatably mounted on the first end 12a of the handle 12, and the roller supports 203 and 204 are rotatably mounted on the second end 12b of the handle 12. As illustrated in FIG. 35, the rotational axes 303 in the two roller supports 201 and 202 are mutually located on the same plane S1. The rotational axes 303 in the other two roller supports 203 and 204 are mutually located on the same plane S2.

As illustrated in FIGS. 38 and 40, stopper rings 34 are interposed between the handle 12 and the roller supports 201 to 204, and a spring 33 that is a torsion spring is provided for each roller unit shaft 30 in the same way as in the aforementioned examples. Thereby, each of the roller supports 201 to 204 is biased to return to a predetermined initial position.

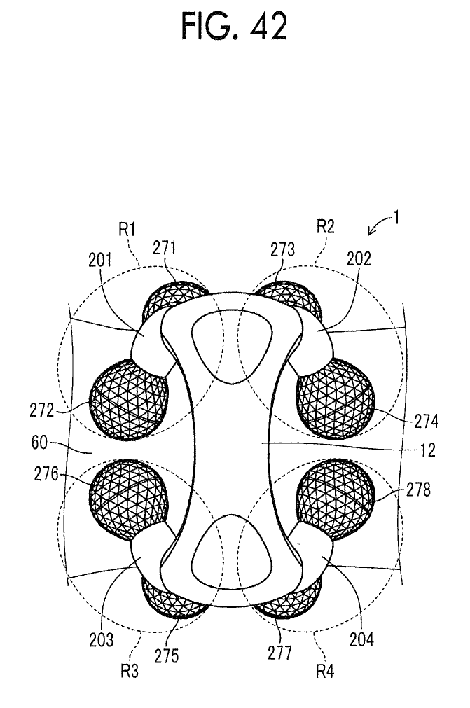

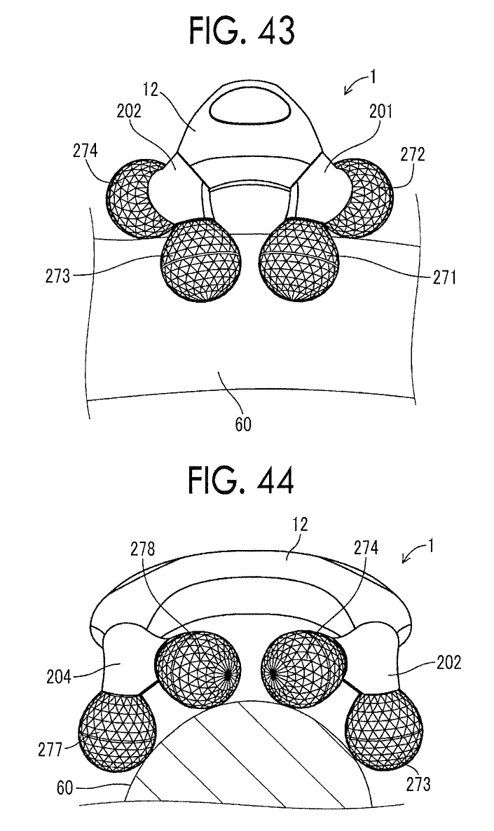

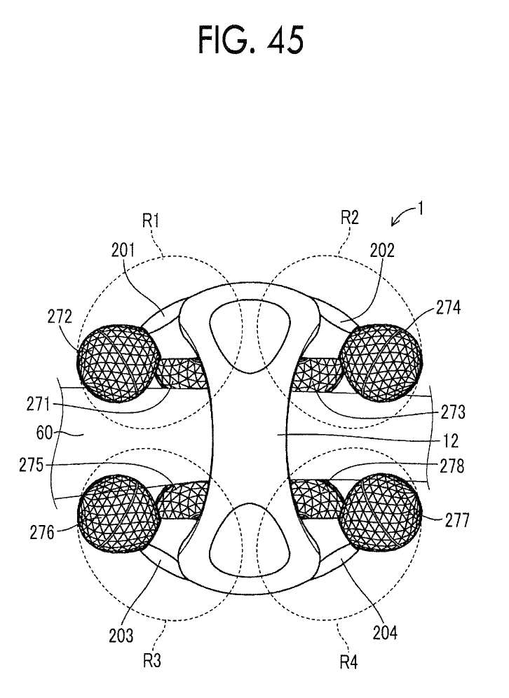

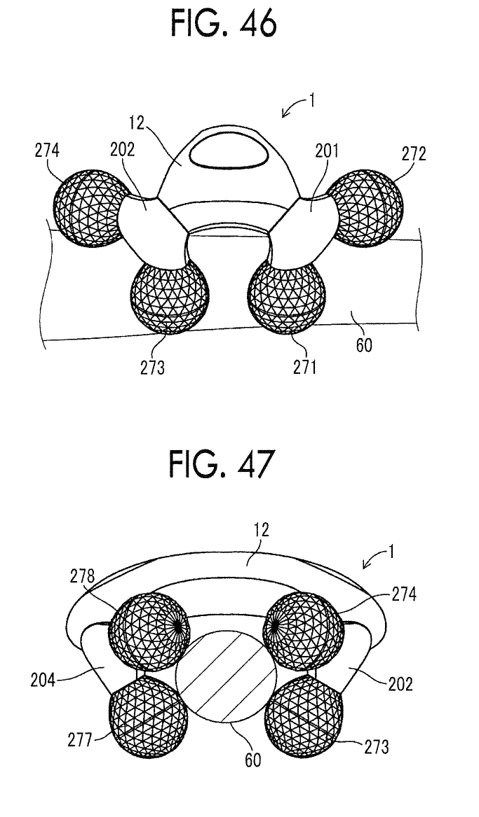

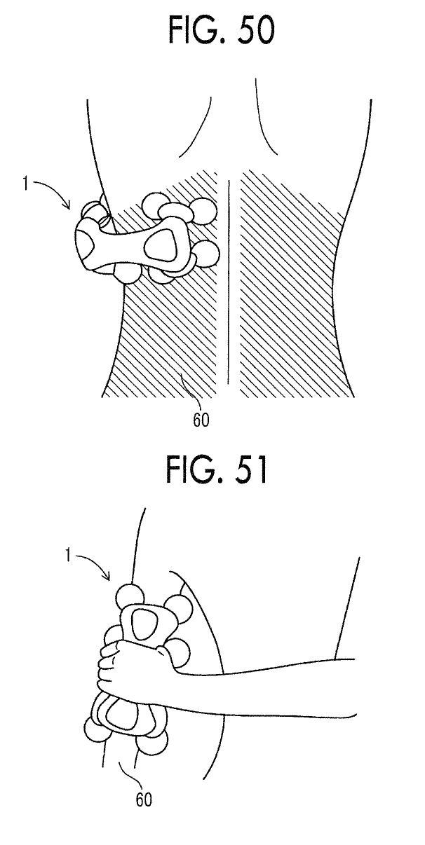

In this example, the roller supports 201 to 204 set states shown in FIGS. 34 to 37 as the initial positions. The roller supports 201 to 204 can be rotated about the rotational axes 303 within a range from −90° shown in FIGS. 42, 43 and 44 to 90° shown in FIGS. 45, 46 and 47 from the initial positions. As illustrated in FIGS. 42 and 45, movable loci R1, R2, R3, and R4 in the rollers 271 to 278 provided for the roller supports 201, 202, 203, and 204 are spaced apart from one another. Thereby, mutual movable ranges do not overlap with one another.

As illustrated in FIG. 36, when viewed from the predetermined lateral side Y2, the rotational axes 303 in at least two neighboring roller supports 201 and 202 are separated from each other from the handle 12 to the lower side Z2. In this example, an angle α formed by the rotational axes 303 in the two roller supports 201 and 202 becomes 100°.

As illustrated in FIG. 35, the pair of roller supports 201 and 202 are arranged symmetrically with respect to a virtual straight line L1 passing through the center of the handle 12 such that the rotational axes 303 of the roller unit shafts 30 are located on the same plane S1 at the first end 12a of the handle 12. As illustrated in FIG. 37, when viewed in the transverse direction X, the mutual rotational axes 303 of the pair of roller unit shafts 30 are orthogonal to the virtual reference plane V. As illustrated in FIG. 35, the roller supports 203 and 204 are also identically arranged at the second end 12b of the handle 12.

As illustrated in FIG. 41, when viewed in a direction P of the rotational axis 303 of the roller unit shaft 30 in the roller support 201, the rotational axis 303 of the roller unit shaft 30 is located at a position separated from the virtual straight line GL passing through the centers of gravity G1 and G2 of the pair of rollers 271 and 272. Thereby, the rotational axis 303 and the virtual straight line GL are located at positions skewed from each other. The roller supports 202 to 204 are also configured in the same way. The centers of gravity G1 to G8 (see FIG. 35) of the eight roller 271 to 278 provided for the roller supports 201 to 204 are configured to be able to be located on the same plane.

### Redescription

As illustrated in FIG. 38, the beauty device 1 of this example is moved in the longitudinal direction Y (see FIG. 37) of the handle 12 when used in a state in which the handle 12 is grasped to bring the rollers 271 to 278 into contact with the outer skin 60. In the outer skin 60, a distance between the center position 61 of the contact region with the roller 271 and the intersection position 62 between the rotational axis 303 of the roller unit shaft 30 and the outer skin 60 becomes a trail length TL.

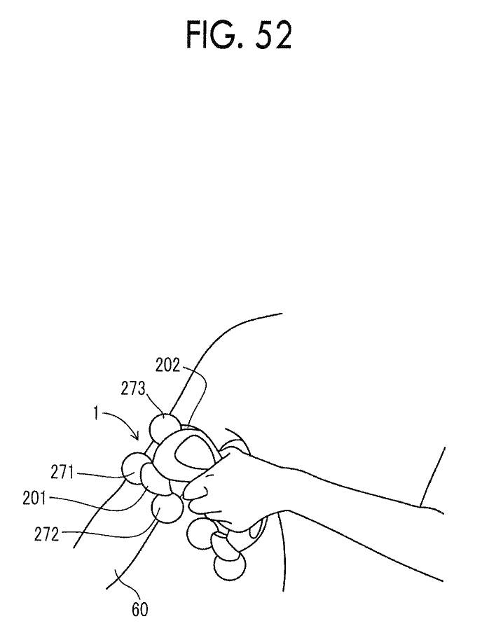

As illustrated in FIGS. 42 to 44 and 50, in the beauty device 1, the outer skin 60 of a human side is adapted to be encompassed by the eight rollers 271 to 278 or the outer skin 60 of a human arm is adapted to be encompassed by the eight rollers 271 to 278 as illustrated in FIGS. 45 to 47 and 51. Thereby, the outer skin 60 can be massaged. As illustrated in FIG. 52, in a state in which the longitudinal direction Y of the handle 12 is nearly orthogonal to a longitudinal direction of the arm, the four rollers 271 to 274 provided for the pair of roller supports 201 and 202 are brought into contact with the arm, and the beauty device 1 is moved in the longitudinal direction of the arm. Thereby, the arm can be massaged by the four rollers 271 to 274. At this point, a user applies the beauty device 1 to the outer skin 60, and thereby the user can rotate the roller supports 201 and 202 such that the rollers 271 to 274 provided therefor easily follow the outer skin 60.

As illustrated in FIGS. 48 and 49, the beauty device 1 is configured such that the eight rollers 271 to 278 can be in contact with the same plane S3.

Next, an operation and effects in the beauty device 1 of this example will be described in detail.

According to the beauty device 1 of this example, the rollers 271 to 278 are located at the lower side Z2 from the handle 12, and are configured such that the rotational axes 303 for the handle 12 in the roller supports 201 to 204 and the virtual straight line GL of both of the centers of gravity G1 and G2 of the two rollers 271 and 27 provided for the roller supports 201 to 204 are located at positions skewed from each other. When viewed from the predetermined lateral side Y2, the rotational axes 303 in the at least two neighboring roller supports 201 and 202 are separated from each other with the approach from the handle 12 to the lower side Z2. For this reason, in a state in which a total of eight rollers 271 to 278 are all brought into contact with the outer skin 60 that is relatively greatly bent such as an arm, a foot, a waist, a side, or the like, the eight rollers 271 to 278 can be moved along the outer skin 60, and these various portions can be treated such that they are encompassed by a total of eight rollers 271 to 278. With this configuration, the rollers 271 to 278 easily follow the outer skin 60, and the wrist need not be excessively twisted during the treatment. Thus, the easy-to-use is obtained.

For example, in the beauty device having a conventional configuration, when in use, when the handle is grasped by a right hand for treatment of a left side, the beauty device should be set in a state in which the wrist is greatly twisted to erect the handle with respect to the outer skin in order to apply the rollers to the outer skin. However, according to the beauty device 1 of this example, even when the handle is grasped by a right hand for treatment of a left side, the roller supports 201 to 204 are rotated. Thereby, although the wrist is not greatly twisted to erect the handle 12 with respect to the outer skin 60, the treatment can be performed by applying the rollers 271 and 278 to the outer skin 60. Thereby, the use becomes still easier.

Further, in the beauty device 1 of this example, movable places are relatively reduced, and the configuration is simplified. In addition, the outer skin is encompassed by the eight rollers 271 to 278. Thereby, a close-contact characteristic between the rollers and the outer skin is enhanced, and the excellent massage effect can be exerted.

In this example, the four roller supports 201 to 204 are located at the apexes 71 to 74 of the virtual rectangle 70 on the virtual reference plane V. Thereby, intervals between the neighboring roller supports 201 to 204 are present in two types, a long interval part at which the interval corresponds to the long side 701 of the virtual rectangle 70 and a short interval part at which the interval corresponds to the short side 702 of the virtual rectangle. Thereby, in the case of intervals between the rollers 271 to 278 in the neighboring roller supports 201 to 204, a portion of a long interval and a portion of a short interval are formed. A user can appropriately select whether the treatment is performed by which of the portion of the long interval and the portion of the short interval between the rollers 271 to 278 by changing a traveling direction according to a region to be treated, and the use becomes still easier.

In this example, the rotational axes 303 in the two roller supports 201 and 202 among the four roller supports 201 to 204 are mutually located on the same plane S1. Thereby, the outer skin is easily encompassed between the rollers 271 to 274 in the two roller supports 201 and 202, and the use becomes easier.

In this example, the rotational axes 303 in the other two roller supports 203 and 204 among the four roller supports 201 to 204 are mutually located on the same plane S2. Thereby, in addition to the two roller supports 201 and 202, the outer skin is easily encompassed between the rollers 275 to 278 in the two roller supports 203 and 204, and the use becomes easier.

In this example, the handle 12 is bent in an arch shape to protrude to the upper side Z1. Thereby, all of the rollers 271 to 278 are easily brought into contact with the outer skin 60 in a state in which the handle 12 is grasped by one hand. A force from the handle 12 is easily transferred to the rollers 271 to 278, and the rollers 271 to 278 can be strongly pressed against the body.

In this example, the two rollers among the rollers 271 to 278 in the roller supports 201 to 204 are rotatably supported by the distal ends 211a and 212a that are free ends of the pair of roller shafts 211 and 212 that are supported by the roller support 201 and are inclined such that the free end sides thereof are open. Thereby, the rotational axes 303 of the rollers 271 to 278 are disposed in a tapered shape. Thus, when the rotational axes 303 of the rollers 271 to 278 are forwardly inclined with respect to the traveling direction, the rollers 271 to 278 are rotated to forcibly spread out the surrounding skin downward on the outer skin 60, and thereby the outer skin 60 can be pressed. When backwardly inclined, the rollers 271 to 278 are rolled up to lift the surrounding skin upward on the outer skin 60, and thereby the outer skin 60 can be picked up, and the excellent massage effect is exerted. Further, in the picked-up state, the close-contact characteristic between the rollers 271 to 278 and the outer skin 60 is further enhanced, and thus the state in which the rollers 271 to 278 and the outer skin 60 are in close contact with each other is easily maintained. As a result, when the beauty device 1 is moved along the outer skin 60, followability of the rollers 271 to 278 is improved.

In this example, shapes of the rollers 271 to 278 are spherical shapes. Thereby, wide ranges of surfaces of the rollers 271 to 278 are easily brought into contact with the outer skin 60, and the massage effect can be further improved.

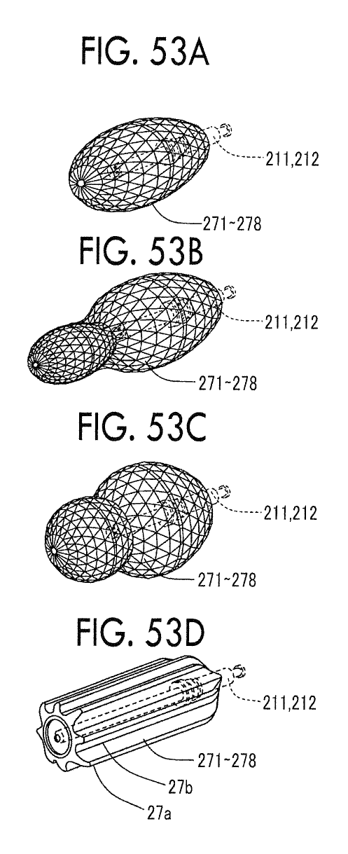

The shape of each of the rollers 271 to 278 may be adapted to have any one of an oval sphere shape, a ruby-ball shape, a gourd shape, a potbelly shape, and a combination thereof in addition to the spherical shape. For example, each of the rollers 271 to 278 may have the oval sphere shape as illustrated in FIG. 53A, the gourd shape as illustrated in FIG. 53B, or the potbelly shape as illustrated in FIG. 53C. In these cases, the wide ranges of surfaces of the rollers 271 to 278 are easily brought into contact with the outer skin 60, and the massage effect can be further improved.

As illustrated in FIG. 53D, a plurality of ribbed protrusions 27a and a plurality of streaked grooves 27b may be formed in the surfaces of the rollers 271 to 278. In this case, due to the protrusions 27a and the grooves 27b, the pressing effect of the outer skin can be enhanced, and the picking-up effect of the outer skin can be improved.

In this example, the four roller supports 201 to 204 are configured such that the movable loci R1 to R4 of the rollers 271 to 278 supported by the roller supports 201 to 204 different from one another. Thereby, the neighboring rollers 271 to 278 are prevented from coming into contact with one another between the different roller supports 201 to 204. As a result, it is possible to inhibit the skin from being sandwiched between the neighboring rollers 271 to 278.

In this example, the roller supports 201 to 204 are configured to set the initial positions as reference positions and to be able to be rotated −90° to 90° about the rotational axes 303 from the reference positions. However, in place of this, the roller supports 201 to 204 may be configured to be able to be rotated at least 360° about the rotational axes 303. In this case, the rollers 271 to 278 can be rotated at least one or more turns via the roller supports 201 to 204, and the use becomes still easier.

In this example, the eight rollers 271 to 278 are configured to be able to come into contact with the same plane S3 at the same time. Thereby, the eight rollers 271 to 278 are reliably brought into contact with the skin, and the massage effect can be exerted.

In this example, the roller unit shafts 30 are adopted as rotating supports that rotatably support the roller supports 201 to 204 on the handle 12. However, the configurations of the rotating supports are not limited thereto, and a well-known configuration may be adopted. For example, the configurations of the rotating supports may be set as in modifications represented by (1) to (5) to be described below.

As described above, according to this example, the beauty device 1 that can be used in the various regions of the body and is easy to use can be provided.

### Example 10

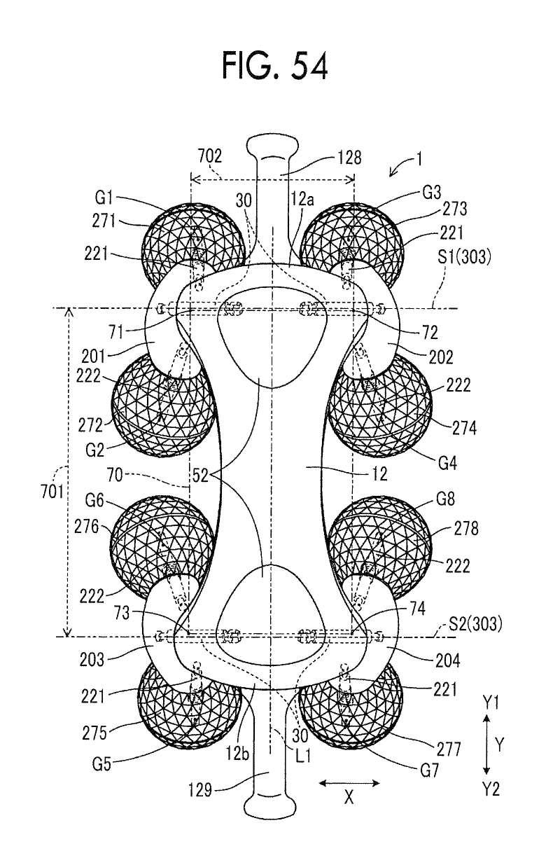

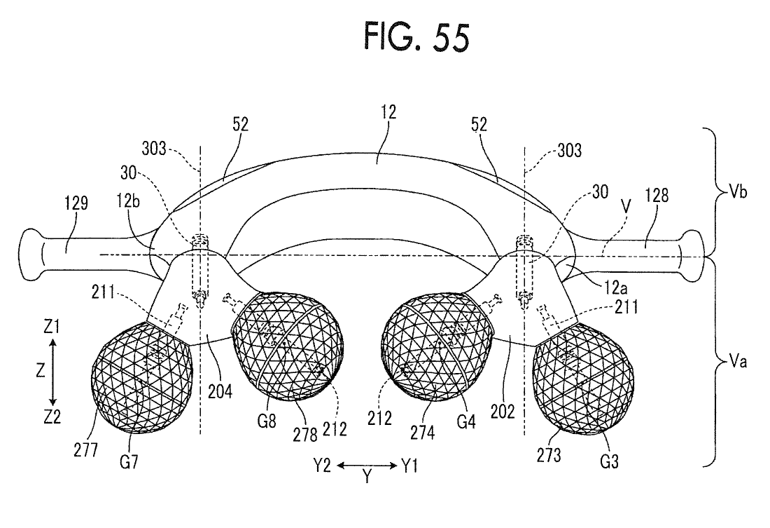

In the beauty device 1 of Example 10, as illustrated in FIGS. 54 and 55, a first grasping part 128 that can be grasped is formed at a first end 12a of a handle 12, and a second grasping part 129 that can be grasped is formed at a second end 12b. The first grasping part 128 has an approximately rod shape, and protrudes in a first end direction Y1 of a longitudinal direction Y. The second grasping part 129 protrudes in a second end direction Y2 of the longitudinal direction Y. The same constituent elements as in Example 9 will be given the same reference signs, and description will be omitted.

According to the beauty device 1 of this example, the first and second grasping parts 128 and 129 provided for the handle 12 can be grasped to perform treatment. Especially, when an aesthetician or the like performs treatment on another person, the first and second grasping parts 128 and 129 are grasped by both hands, and thereby the beauty device 1 can be stably grasped. For this reason, a force applied to the beauty device 1 via the first and second grasping parts 128 and 129 is easily adjusted, and the outer skin can be more strongly pressed. Thereby, the massage effect is improved.

### Transfer

In Examples 1 to 10, the roller unit shafts 30 are adopted as the rotating supports that rotatably support the roller units 20 (201 to 204). The configuration of the rotating supports is not limited thereto, and a well-known configuration may be adopted. For example, the configuration of the rotating supports may be set as in the modifications represented by (1) to (5) below:
(1) The roller unit shafts 30 may be fixed to the roller units 20 (201 to 204), and be adapted to be rotatably supported inside the handle 12.
(2) A radial ball bearing having an outer ring, an inner ring coaxially provided inside the outer ring, and a plurality of rolling elements held between both of the rings is provided. The handle 12 is fixed to one of the outer and inner rings, and the roller unit 20 is fixed to the other. The roller units 20 (201 to 204) may be adapted to be rotatably supported by the handle 12. In this case, axes of the outer and inner rings become the rotational axes 303 of the roller units 20 (201 to 204).
(3) A thrust ball bearing is provided in which a plurality of rolling elements are held by two track plates and the track plates are configured to be mutually rotatable via the rolling elements. The handle 12 is fixed to one of the two track plates, and the roller units 20 (201 to 204) are fixed to the other. The roller units 20 (201 to 204) may be adapted to be rotatably supported by the handle 12. In this case, a virtual line passing through the center of rotation of each of the track plates become the rotational axis 303 of the roller unit 20.
(4) A slide bearing is formed in which an outer tube part having a tubular shape is formed at one of the handle 12 and the roller units 20 (201 to 204), an inner tube part having an outer diameter corresponding to an inner diameter of the outer tube part is formed at the other, the inner tube part is inserted inside the outer tube part, and the inner tube part is coaxially rotatable relative to outer tube part, and thereby the roller units 20 (201 to 204) may be adapted to be rotatably supported by the handle 12. To prevent the inner tube part from coming out in a state in which the inner tube part is inserted into the outer tube part, for example an engaging part for engaging an inner wall of the outer tube part with a distal end of the inner tube part may be provided, or an engaging part for engaging an outer wall of the inner tube part with a distal end of the outer tuber part may be provided. In this case, axes of the outer and inner tube parts become the rotational axes 303 of the roller units 20 (201 to 204).
(5) A slide bearing in which a spherical protrusion having a rod-shaped base part and a spherical part whose diameter is larger than that of the base part at a distal end of the base part is formed at one of the handle 12 and the roller units 20 (201 to 204), a hole part having a concave shape corresponding to an external shape of the spherical protrusion is formed at the other, and the spherical protrusion is fitted into the hole part is formed. Thereby, the roller units 20 (201 to 204) may be adapted to be rotatably supported by the handle 12. In this case, the centerline of the base part of the spherical protrusion become the rotational axis 303 of the roller unit 20 (201 to 204).

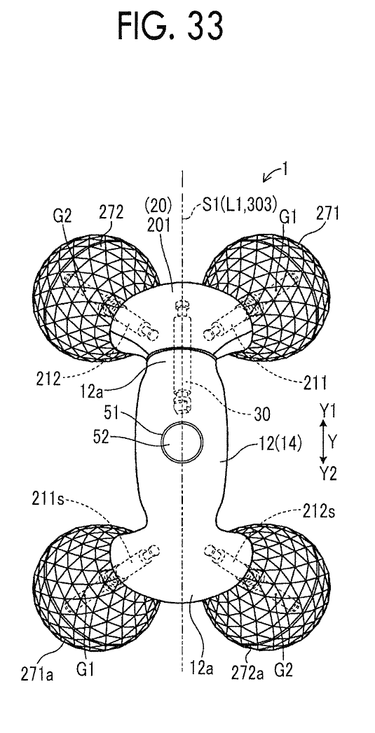

Other modifications are represented in (6) to (15) below:
(6) In Examples 1 to 10, for example, as illustrated in FIG. 20, the locking claws 43 provided for each of the bearings 40 are engaged with the step part 281 provided for each of the rollers 271 and 272, and both are fixed to each other. However, in place of this, claws provided for each of the rollers 271 and 272 may be engaged with a step part provided for each of the bearings 40, and both may be fixed to each other.
(7) In Examples 1 to 10, it is assumed that the handle 12 is grasped by a hand, and is manually moved along the outer skin 60 when in use. However, the handle 12 in the above examples may be mounted on, for example, a powered massage device such as a massage chair, and thereby the beauty device 1 of the above examples may be adapted to be automatically moved along the outer skin 60.
(8) In Examples 1 to 10, the shape of each of the rollers 271 to 278 may adopt an oval shape, a Rugby ball shape, a potbelly shape in which two spheres are connected, a gourd shape, a conical shape, etc. in addition to a spherical shape and a cylindrical shape, or the surface thereof have such irregularities as to be rotatable. A plurality of rib-shaped protrusions or a plurality of streaky grooves may be formed in the surface of each of the rollers 271 to 278.
(9) In Examples 1 to 10, the solar cell is used as a power supply for giving electrical stimuli to the skin. However, in place of this, a power supply such as a dry cell may be used.
(10) In Examples 1 to 10, the conduction path is set such that the user grasps the handle 12, and the rollers 271 to 278 come into contact with the outer skin 60, and thereby, a the handle 12 and the rollers 271 to 278 are electrically connected via a human body, and a closed circuit is formed. However, in place of this, the conduction path may be set such that each of the rollers 271 to 278 comes into contact with the outer skin 60, and thereby a closed circuit is formed between the arbitrary rollers 271 to 278 via the human body.
(11) In Examples 1 to 10, the roller shafts 211 and 212 are fixed to the roller units 20 (201 to 204), and rotatably support the rollers 271 to 278. However, in place of this, the roller shafts 211 and 212 may be rotatably supported by the roller units 20 (201 to 204), and the rollers 271 to 278 may be fixed thereto. That is, the rollers 271 to 278 may be adapted to be provided to be rotatable integrally with the roller shafts 211 and 212.
(12) In Examples 1 to 10, the roller units 20 (201 to 204) may include a pressing protrusion or a rotatable treating part independently of the pair of rollers 271 to 278.
(13) In Examples 1 to 10, the movable loci R1 to R4 of the rollers 271 to 278 may overlap each other when safety is secured.
(14) Like Modification 5 illustrated in FIG. 33, among the four rollers 271, 272, 271a, and 272a, the two rollers 271 and 272 may be adapted to be rotatably supported by the roller unit 201 via the roller shafts 211 and 212, and the other two rollers 271a and 272a may be adapted to be fixed to one distal end 12b of the handle 12 via the roller shafts 211s and 212s. In this example, the rollers 271a and 272a have the same configuration as the rollers 271 and 272, and the roller shafts 211s and 212s have the same configuration as the roller shafts 211 and 212.
(15) In Examples 1 to 10, the roller units 20 (201 to 204) may provide a step-by-step displacement or rotary lock mechanism caused by a ratchet mechanism for the handle 12. In this case, the roller units can be continuously used by desired roller arrangement.

1-6. (canceled)

7. A beauty device comprising:
a handle;
a roller unit having two rotatable rollers; and
a roller unit shaft interposed between the roller unit and the handle and configured to rotatably support the roller unit with respect to the handle,
wherein, when viewed in a direction of an axis of the roller unit shaft, the axis of the roller unit shaft is located at a position separated from a virtual straight line passing through centers of gravity of the two rollers.

8. The beauty device according to claim 7, wherein the roller unit includes a pair of roller shafts that rotatably support the rollers at distal ends thereof and are provided such that the distal ends are open.

9. The beauty device according to claim 8, wherein:
a proximal end side of the roller unit shaft and the handle are connected, and a distal end side of the roller unit shaft and the roller unit are connected; and
the pair of roller shafts are located on the same plane, and are inclined with respect to the axis of the roller unit shaft.

10. The beauty device according to claim 7, wherein the roller unit is provided in at least one pair.

11. The beauty device according to claim 7, wherein the pair of roller units are disposed symmetrically with respect to a central axis of the handle.

12. The beauty device according to claim 7, wherein the roller unit is provided in at least two pairs.

13. The beauty device according to claim 8, wherein the roller unit is provided in at least one pair.

14. The beauty device according to claim 9, wherein the roller unit is provided in at least one pair.

15. The beauty device according to claim 8, wherein the pair of roller units are disposed symmetrically with respect to a central axis of the handle.

16. The beauty device according to claim 9, wherein the pair of roller units are disposed symmetrically with respect to a central axis of the handle.

17. The beauty device according to claim 10, wherein the pair of roller units are disposed symmetrically with respect to a central axis of the handle.

18. The beauty device according to claim 8, wherein the roller unit is provided in at least two pairs.

19. The beauty device according to claim 9, wherein the roller unit is provided in at least two pairs.

20. The beauty device according to claim 10, wherein the roller unit is provided in at least two pairs.

21. The beauty device according to claim 11, wherein the roller unit is provided in at least two pairs.
